(19) United States
(12) Patent Application Publication
(10) Pub. No.: US 2025/0350378 A1
(43) Pub. Date: Nov. 13, 2025

(54) SIGNALING USING DIFFERENT SYMBOL DURATIONS

(71) Applicant: QUALCOMM Incorporated, San Diego, CA (US)

(72) Inventors: Ahmed Abdelaziz Ibrahim Abdelaziz ZEWAIL, San Diego, CA (US); Piyush GUPTA, Bridgewater, NJ (US); Raviteja PATCHAVA, San Diego, CA (US)

(21) Appl. No.: 19/200,395

(22) Filed: May 6, 2025

Related U.S. Application Data
(60) Provisional application No. 63/645,744, filed on May 10, 2024.

(51) Int. Cl. H04B 17/11; H04L 27/02

(52) U.S. Cl. CPC H04B 17/11; H04L 27/02

(57) ABSTRACT

Aspects relate to signaling for Internet of Things (IoT) devices and other similar devices (e.g., energy harvesting devices). In some examples, an apparatus (e.g., a reader) transmits a preamble and associated data using different symbol lengths. In some examples, an apparatus (e.g., an IoT device) receives a preamble and associated data using different symbol lengths.

### CROSS-REFERENCE TO RELATED APPLICATIONS

The present application for patent claims priority to and the benefit of pending U.S. Provisional Application No. 63/645,744, titled “SIGNALING USING DIFFERENT SYMBOL DURATIONS” filed May 10, 2024, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to signaling that uses different symbol durations for a preamble and data.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station. A base station may schedule access to a cell to support access by multiple UEs. For example, a base station may allocate different resources (e.g., time domain and frequency domain resources) to be used by different UEs operating within the cell.

A communication system may support radio frequency identification (RFID) based communication. In some examples, RFID communication may involve interactions between an RFID reader and an RFID tag. In some examples, the RFID reader may transmit a continuous wave (CW) radio frequency (RF) signal or some other type of RF signal to activate (e.g., power up, wake up, initiate a response at, etc.) the RFID tag. Once activated by the RF signal, the RFID tag may use a backscatter technique or some other technique to send an information signal to the RFID reader (e.g., in response to a query from the RFID reader sent via the RF signal). Thus, the RFID reader may transmit RF signals to activate an RFID tag and then receive data sent by the RFID tag.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

An aspect of the disclosure relates to an apparatus. The apparatus includes one or more memories and one or more processors coupled to the one or more memories. The one or more processors are configured to transmit a preamble according to a first symbol duration, and transmit data associated with the preamble. The data may be transmitted according to a second symbol duration that is different from the first symbol duration.

Another aspect of the disclosure relates to a method for wireless communication at an apparatus. The method includes transmitting a preamble according to a first symbol duration, and transmitting data associated with the preamble. The data may be transmitted according to a second symbol duration that is different from the first symbol duration.

Another aspect of the disclosure relates to an apparatus. The apparatus includes means for transmitting a preamble according to a first symbol duration, and means for transmitting data associated with the preamble. The data may be transmitted according to a second symbol duration that is different from the first symbol duration.

Another aspect of the disclosure relates to a non-transitory computer-readable medium. The non-transitory computer-readable medium has stored therein instructions executable by one or more processors of an apparatus to transmit a preamble according to a first symbol duration, and transmit data associated with the preamble. The data may be transmitted according to a second symbol duration that is different from the first symbol duration.

Another aspect of the disclosure relates to an apparatus. The apparatus includes one or more memories and one or more processors coupled to the one or more memories. The one or more processors are configured to receive a preamble according to a first symbol duration, and receive data associated with the preamble. The data may be received according to a second symbol duration that is different from the first symbol duration.

Another aspect of the disclosure relates to a method for wireless communication at an apparatus. The method includes receiving a preamble according to a first symbol duration, and receiving data associated with the preamble. The data may be received according to a second symbol duration that is different from the first symbol duration.

Another aspect of the disclosure relates to an apparatus. The apparatus includes means for receiving a preamble according to a first symbol duration, and means for receiving data associated with the preamble. The data may be received according to a second symbol duration that is different from the first symbol duration.

Another aspect of the disclosure relates to a non-transitory computer-readable medium. The non-transitory computer-readable medium has stored therein instructions executable by one or more processors of an apparatus to receive a preamble according to a first symbol duration, and receive data associated with the preamble. The data may be received according to a second symbol duration that is different from the first symbol duration.

These and other aspects of the disclosure will become more fully understood upon a review of the detailed description which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a diagram illustrating an example of a radio frequency identification (RFID) system according to some aspects.

FIG. 6 is a block diagram illustrating reader functionality in a wireless communication device according to some aspects.

FIG. 7 is a block diagram illustrating receiver functionality in a wireless communication device according to some aspects.

FIG. 8 is a diagram illustrating an example of signaling according to some aspects.

FIG. 9 is a diagram illustrating another example of signaling according to some aspects.

FIG. 10 is a signaling diagram of an example of signaling and associated operations according to some aspects.

FIG. 11 is a block diagram conceptually illustrating an example of a hardware implementation for an apparatus (e.g., incorporating reader functionality) employing a processing system according to some aspects.

FIG. 12 is a flow chart illustrating an example of a wireless communication method involving signaling according to some aspects.

FIG. 13 is a flow chart illustrating another example of a wireless communication method involving signaling according to some aspects.

FIG. 14 is a flow chart illustrating another example of a wireless communication method involving signaling according to some aspects.

FIG. 15 is a flow chart illustrating another example of a wireless communication method involving signaling according to some aspects.

FIG. 16 is a block diagram conceptually illustrating an example of a hardware implementation for an apparatus (e.g., incorporating ambient Internet of Things (IoT) functionality) employing a processing system according to some aspects.

FIG. 17 is a flow chart illustrating an example of a wireless communication method involving signaling according to some aspects.

FIG. 18 is a flow chart illustrating another example of a wireless communication method involving signaling according to some aspects.

FIG. 19 is a flow chart illustrating another example of a wireless communication method involving signaling according to some aspects.

FIG. 20 is a flow chart illustrating another example of a wireless communication method involving signaling according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution. The various concepts presented throughout this disclosure may be implemented across a broad variety of telecommunication systems, network architectures, and communication standards.

Various aspects of the disclosure relate to signaling for Internet of Things (IoT) devices. In some examples, a first apparatus (e.g., a reader) transmits a preamble and associated data using different symbol lengths. In addition, a second apparatus (e.g., an IoT device) receives the preamble and associated data using the different symbol lengths. By using different symbol lengths, tradeoffs may be made between providing a signal that can be detected more effectively and providing a higher information rate. For example, the first apparatus may use a longer symbol length when transmitting the preamble to enable the second apparatus, which may be a relatively low power device, to more easily detect the preamble. Once the second apparatus has recognized the preamble, the second apparatus will be able to readily detect subsequent information (e.g., data) that the first apparatus transmits using a shorter symbol duration. Thus, the information may be transmitted at a higher data rate which improves system performance.

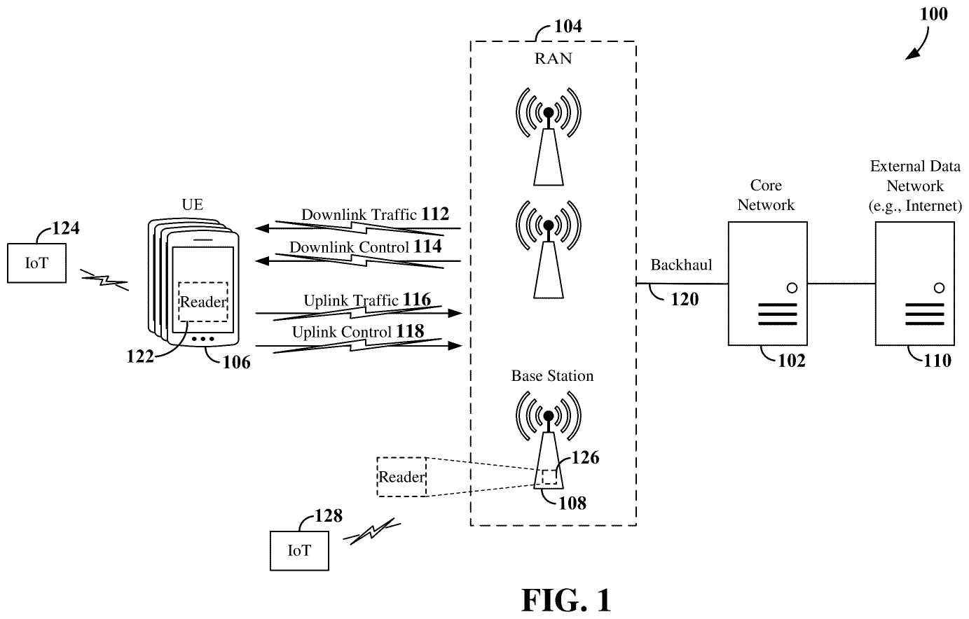

Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104 (e.g., including base stations 108), and user equipment (UE) 106. By virtue of the wireless communication system 100, the UE 106 may be enabled to carry out data communication with an external data network 110, such as (but not limited to) the Internet.

In addition, the UE 106 may include reader functionality 122 that can transmit a signal to at least one IoT device (e.g., an IoT device 124) and receive information from the at least one IoT device. For example, the UE 106 may transmit a continuous wave (CW) radio frequency (RF) signal that can activate circuitry on the IoT device 124. In addition, the UE 106 may demodulate and decode backscatter signals from the IoT device 124 to thereby recover information modulated onto the backscatter signals by the IoT device 124. The IoT device 124 may transmit, and the UE 106 may receive, the information in other ways in other examples.

Similarly, a network entity (e.g., a base station 108) may include reader functionality 126 that can transmit an signal to at least one IoT device (e.g., an IoT device 128) and receive information from the at least one IoT device. For example, the network entity may transmit a CW RF signal that can activate circuitry on the IoT device 128. In addition, the network entity may demodulate and decode backscatter signals from the IoT device 128 to thereby recover information modulated onto the backscatter signals by the IoT device 128. The IoT device 128 may transmit, and the network entity may receive, the information in other ways in other examples.

In each of the above scenarios, the signal transmitted by the UE 106 or the network entity may include a preamble and data, and optionally a clock calibration signal. In some aspects, the symbol duration used to transmit the preamble may be different from (e.g., longer than) the symbol duration used to transmit the data. Thus, a relative energy gain may be provided for detecting the preamble. In addition, a higher data rate may be achieved when transmitting the data. Similarly, the symbol duration used to transmit the preamble may be different from (e.g., longer than) the symbol duration used to transmit the clock calibration signal.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (CNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network—New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

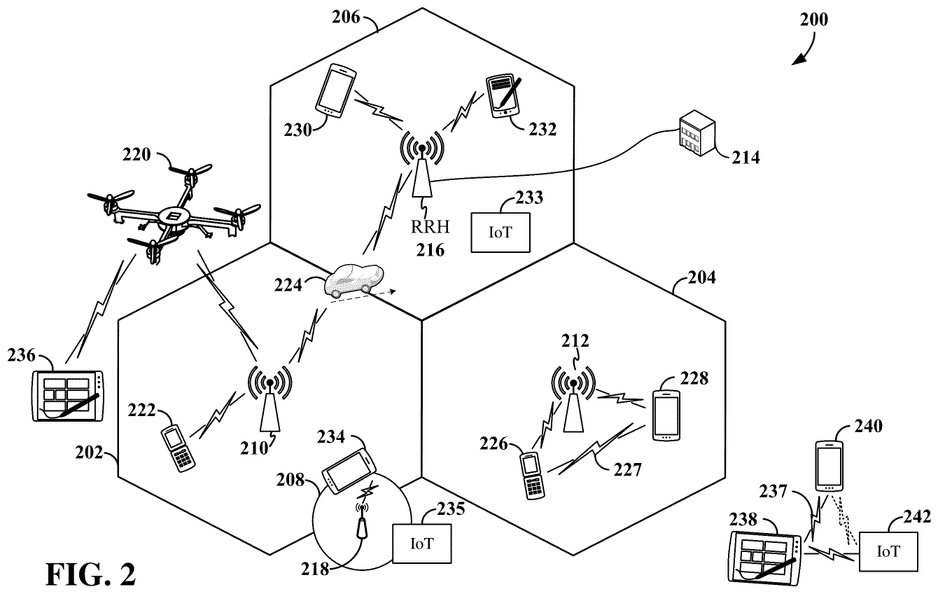

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 and other devices (e.g., an IoT device 233) may be in communication with base station 214 by way of RRH 216; and devices such as a UE 234 and an IoT device 235 may be in communication with base station 218 (e.g., a microcell). In some examples, the UEs 222, 224, 226, 228, 230, 232, 234, 236, 238, and/or 240 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238 and 240) and/or other devices (e.g., an IoT device 242) may communicate with each other using sidelink signals 237 without relaying that communication through a base station. In some examples, one or more of the UEs 238 and 240 and the IoT device 242 may function as a scheduling entity or transmitting sidelink device and/or a scheduled entity or a receiving sidelink device to schedule resources and communicate sidelink signals 237 therebetween without relying on scheduling or control information from a base station. In other examples, two or more devices (e.g., UEs 226 and 228, IoT devices, etc.) within the coverage area of a base station (e.g., base station 212) may also communicate sidelink signals 227 over a direct link (sidelink) without conveying that communication through the base station 212. In this example, the base station 212 may allocate resources to the devices (e.g., UEs 226 and 228) for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum often is subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

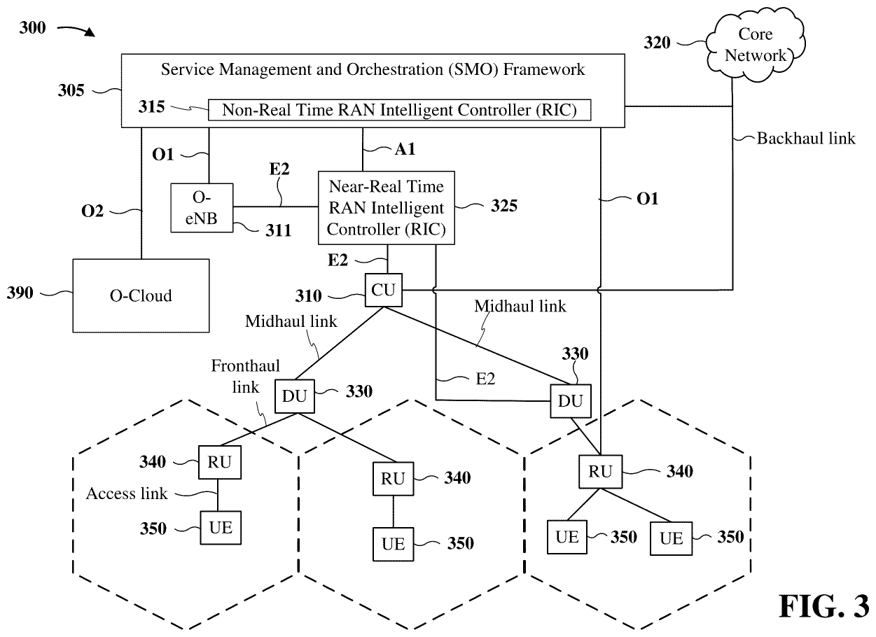

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

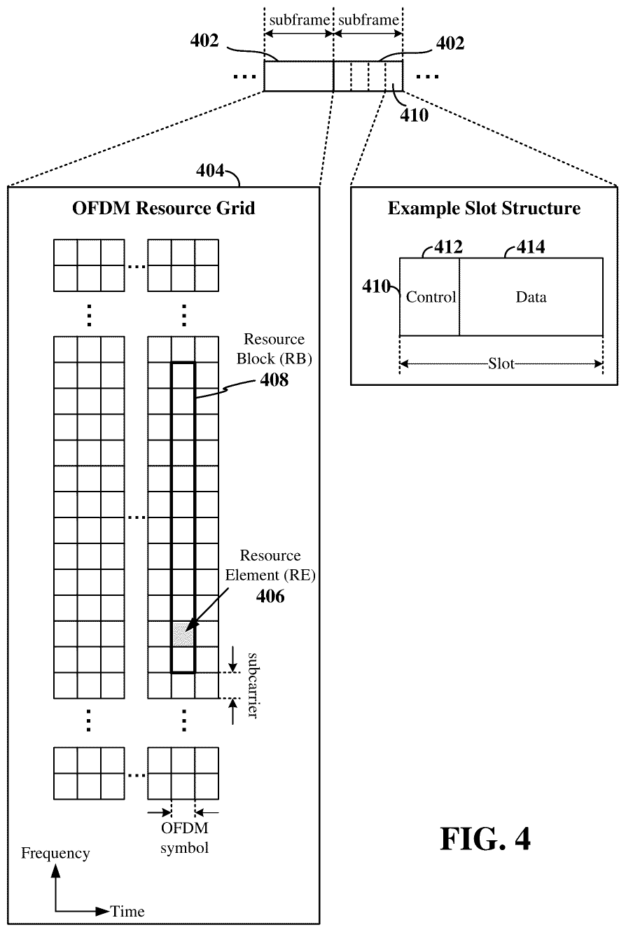

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, cNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

RFID is used in a wide variety of applications including, for example, identification devices, inventory tracking, assembly line processes, access control, and so on. RFID communication is a rapidly growing technology impacting many industries due to its economic potential for inventory/asset management (e.g., inside and outside of warehouses), IoT, sustainable sensor networks in factories and/or agriculture, and smart home devices. In some examples, RFID communication involves the use of small transponders (typically referred to as tags) that emit an information-bearing signal upon receiving a signal. RFID devices may soon become the most pervasive microchip devices in history. In some implementations, an RFID device can be operated without a battery, with low operating expense, low maintenance cost, and a long life cycle. For example, a passive RFID device can harvest energy over the air and power internal transmission/reception circuitry where the transmitted signal is typically backscatter modulated. Semi-passive or active RFID devices that include a battery may also be used, albeit at higher cost.

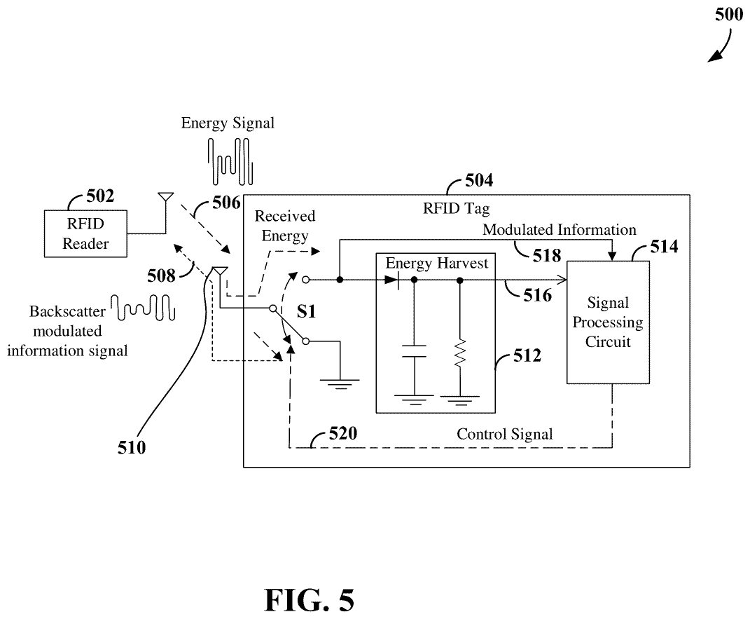

FIG. 5 illustrates an example RFID system 500 in accordance with another aspect of the disclosure. The RFID system 500 includes an RFID reader 502 and an RFID tag 504. In this example, the RFID tag 504 is a passive tag (e.g., the RFID tag 504 does not include its own power source) and uses a backscattering technique to send information to the RFID reader 502.

The RFID reader 502 transmits an energy signal 506 (e.g., a CW RF signal) that can be received by the RFID tag 504 when the RFID tag 504 and the RFID reader 502 are relatively close to one another. In general, the operable distance is implementation specific. The RFID tag 504 uses the energy from the energy signal 506 to power internal circuitry (e.g., energy reflecting and modulation circuitry) and thereby modulate information on the energy signal. Thus, the RFID tag 504 transmits a backscatter signal 508 that is modulated with this information to the RFID reader 502. The RFID reader 502 includes circuitry to demodulate and decode the backscatter signal 508 to recover the information sent by the RFID tag 504.

In the example of FIG. 5, the RFID tag 504 includes an antenna 510, a switch S1 for selectively switching the antenna 510 to different internal nodes, an energy harvest circuit 512, and a signal processing circuit 514 (e.g., one or more processors). An RFID tag may include other circuitry in other examples.

When the RFID tag 504 is inactive, the switch SI couples the antenna 510 to the energy harvest circuit 512. In this way, when the energy signal 506 is received, the energy harvest circuit 512 will charge its capacitor, and thereby provide a supply voltage 516 to the signal processing circuit 514.

Upon activation of the signal processing circuit 514, the signal processing circuit 514 may decode any modulated information (e.g., a query) 518 carried by the energy signal 506. Upon decoding the information, the signal processing circuit 514 may generate information to be sent to the RFID reader 502 and control a backscatter circuit to generate the backscatter signal 508 modulated with this information (e.g., by controlling the switch SI via a control signal 520 to backscatter modulate the energy signal 506 based on the information and thereby generate the backscatter signal 508). Other RFID tags may operate in a similar or different manner.

3GPP 5G technology is expanding to industrial cases beyond enhanced mobile broadband (cMBB), e.g., ultra-reliable low-latency communication (URLLC) and machine type communication (MTC). For example, 5G and beyond may be expanded to support passive IoT. 3GPP has developed specifications to support MTC/narrowband-IoT (NB-IoT), and reduced capability (RedCap) UEs for MTC use cases. However, current versions of 5G might not efficiently support the most pervasive RFID types of sensors (e.g., passive IoT devices) in many future use cases (e.g., asset management, logistics, warehousing, and manufacturing).

The disclosure relates in some aspects to network management of passive IoT devices. For example, a network entity such as a gNB may read information stored on passive IoT devices and write information to these devices (e.g., in a similar manner as RFID information may be read and written). To this end, the network entity may provide energy to the passive IoT devices, whereby information-bearing signals may be reflected to the network entity. The network entity may then read the reflected signals from the passive IoT devices to decode the information transmitted by the IoT devices.

A reader may be implemented in various types of devices. In some examples, a reader may be implemented in a device that supports other forms of wireless communication.

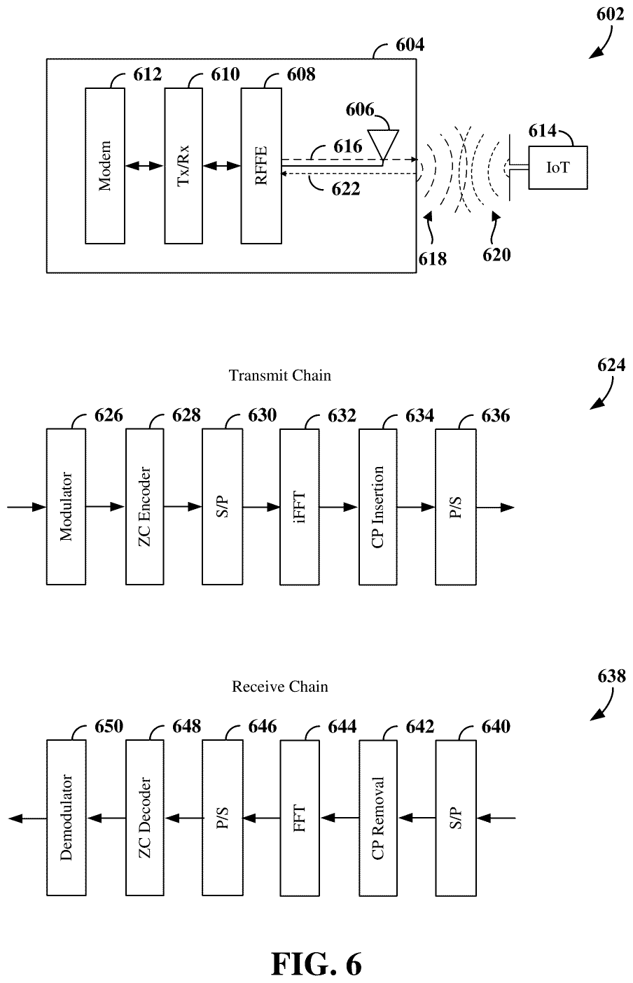

FIG. 6 illustrates an example system 602 including an apparatus 604 that incorporates reader circuitry in accordance with certain aspects of the disclosure. The apparatus 604 may be a UE, a network entity (e.g., a gNB), or some other type of wireless communication device. In some examples, the apparatus 604 may correspond to any of the readers, UEs, scheduled entities, network entities, base stations, CUs, DUs, RUs, or scheduling entities shown in any of FIGS. 1-3, 5, 10, and 11.

The apparatus 604 includes an antenna 606, an RF front end (RFFE) module 608, a transceiver 610, and a modem 612 that may be used for transmitting wireless communication signals to and receiving wireless communication signals from other wireless communication devices.

Using these components, the apparatus 604 implements reader functionality that is used to read information from an IoT device 614. For example, the reader functionality may generate an on-off keying (OOK) signal 616 that is transmitted via the antenna 606 as an over-the-air RF signal 618. Responsive to the over-the-air RF signal 618, the IoT device 614 outputs a modulated over-the-air signal 620 that carries information to be read by the reader functionality. The antenna 606 receives the over-the-air signal 620, whereby a corresponding modulated signal 622 (which may be referred to as the reflected signal) is provided to the reader functionality via the RFFE module 608. In some examples, the IoT device 614 may correspond to any of the IoT devices or RFID tags shown in any of FIGS. 1, 2, 5, 7, 10, and 16.

FIG. 6 also illustrates an example of a transmit chain 624 and a receive chain 638 of the apparatus 604. As discussed below, these circuits are used to transmit and receive OFDM-based signals. Other apparatuses that support reader functionality may use other types of transmit chains and receive chains and other forms of signaling.

The transmit chain 624 includes a modulator 626 that modulates a signal (e.g., based on OOK) to be transmitted. The modulated signal is encoded by a Zadoff-Chu (ZC) encoder 628 so that corresponding ZC sequences are transmitted on OFDM subcarriers (tones) according to the OOK modulation. A serial-to-parallel (S/P) converter 630 converts the serial encoded signal to a parallel signal. An inverse fast Fourier transform (iFFT) module 632 converts the parallel signal from the frequency domain to the time domain. A cyclic prefix (CP) insertion module 634 adds CPs to the time domain signal. A parallel-to-serial converter 636 converts the parallel time domain signal to a serial signal for output by the RFFE module 608.

The receive chain 638 includes a serial-to-parallel (S/P) converter 640 that converts a serial signal received from the RFFE module 608 to a parallel signal. A cyclic prefix (CP) removal module 642 removes CPs from the parallel signal. A (fast Fourier transform) FFT module 644 converts the parallel signal from the time domain to the frequency domain. A parallel-to-serial converter 646 converts the parallel frequency domain signal to a serial signal. The resulting signal is then decoded by a ZC decoder 648 and demodulated by a demodulator 650 to recover the information from the received signal.

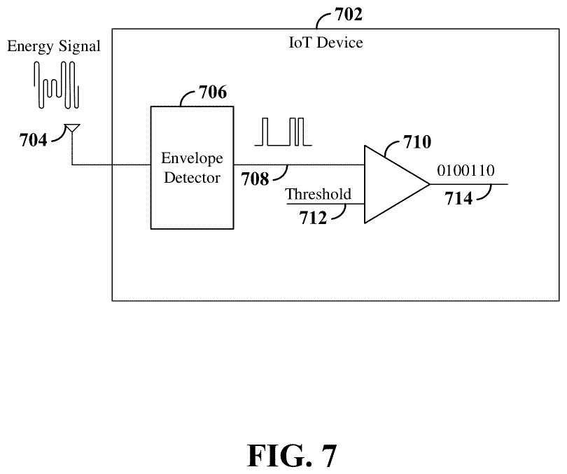

FIG. 7 illustrates an example of receiver circuitry that may be employed in an IoT device 702 (e.g., an ambient IoT device), or any other type of device that receives an information signal as discussed herein. As shown, the IoT device 702 includes an RF envelope detector based receiver (e.g., for detecting OOK signals). To reduce the complexity of FIG. 7, other circuitry (e.g., energy harvest circuitry, backscatter circuitry, memory, processor circuitry, etc.) of the IoT device 702 is not shown. In some examples, the IoT device 702 may correspond to any of the IoT devices or RFID tags shown in any of FIGS. 1, 2, 5, 6, 10, and 16.

The IoT device 702 includes an antenna 704 that couples received energy to an envelope detector 706. In some examples, the envelope detector 706 may include one or more rectifiers and one or more low pass filters. In the example of FIG. 7, the output 708 of the envelope detector 706 is fed to a first input of a comparator 710. The comparator 710 compares the signal at its first input to a threshold voltage 712 at a second input of the comparator 710 to generate an output signal 714. In some examples, the circuitry shown in FIG. 7 may be part of a signal processing circuit (e.g., similar to the signal processing circuit 514 of FIG. 5). Other examples of IoT devices or similar devices may use different receiver circuitry.

As mentioned above, so-called ambient IoT devices refer to IoT devices that can employ energy harvesting (e.g., similar to passive tags). In ambient IoT devices, the local clock is assumed to have a large error due to the use of low-cost technologies. For example, some ambient IoT devices might not use a crystal-based oscillator for clock generation. It is reasonable to assume that the local clock can have an error up to 10% in some cases prior to calibration. Also, ambient IoT devices may be assumed to operate in asynchronous mode. These devices may rely on preamble detection to get an initial timing estimate.

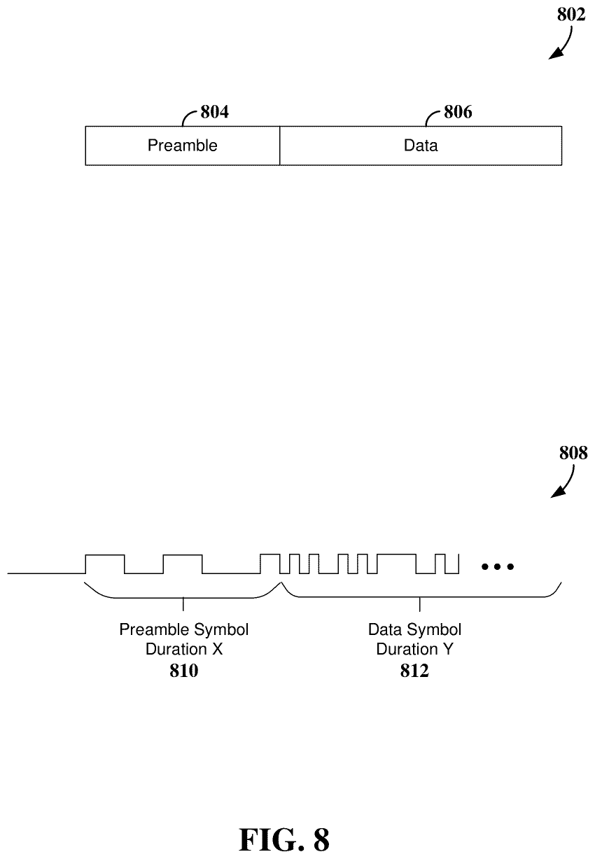

FIG. 8 illustrates an example of signaling for such a device. A first diagram 802 illustrates a signal sent to an ambient IoT device, where the signal includes a preamble 804 and data 806.

When the ambient IoT device searches for the preamble 804, it may be beneficial to use longer symbols than are used for the data 806 so that there is an energy gain while processing the received signal at the receiver. Longer symbols will translate to more samples, assuming a fixed local clock frequency. By using more samples, correlator-based detection performance can be enhanced. After the preamble detection, a local clock calibration signal can be transmitted to calibrate the local clock and reduce clock error. After the calibration, the device may be able to operate with a shorter symbol length for the data 806 while achieving a reasonable performance with a higher data rate.

A second diagram 808 of FIG. 8 illustrates that different symbol durations are used for the preamble 804 and the data 806. Specifically, a symbol duration X is used during the period 810 for the preamble 804 and a shorter symbol duration Y is used during the period 812 for the data 806.

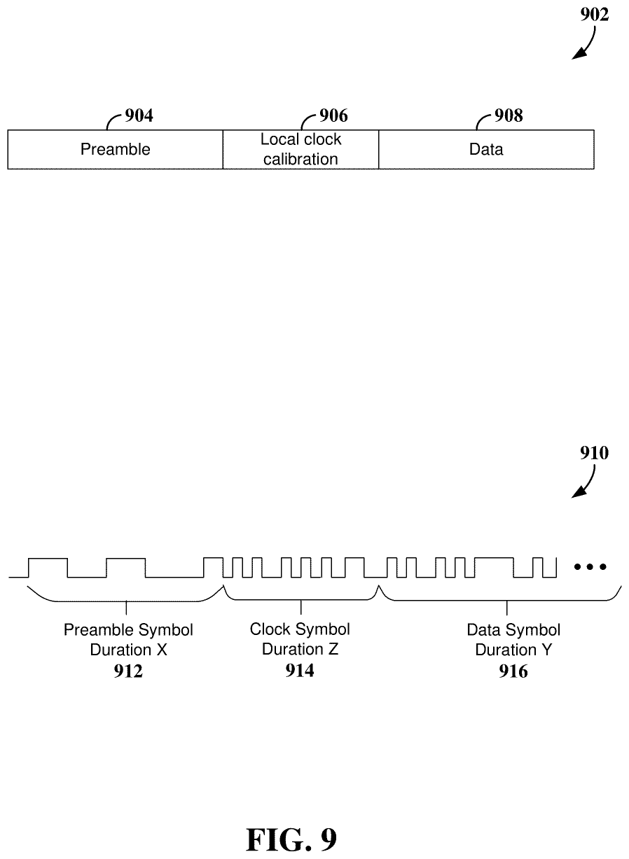

FIG. 9 illustrates another example of signaling that also includes a local clock calibration signal. A first diagram 902 illustrates a signal sent to an ambient IoT device, where the signal includes a preamble 904, a local clock calibration signal 906, and data 908. In some examples, the preamble 904 may be referred to as a start indication part of a reader-to-device (R2D) signal. In some examples, the local clock calibration signal 906 may be referred to as a clock acquisition part of the R2D signal.

A second diagram 910 of FIG. 9 illustrates that different symbol durations may be used for the preamble 904, the local clock calibration signal 906, and the data 908. Specifically, a symbol duration X is used during the period 912 for the preamble 904, a symbol duration Z is used for the period 914 for the local clock calibration signal 906, and a symbol duration Y is used for the period 916 for the data 908. The symbol duration Y is shorter than the symbol duration X in this example.

In some examples, the symbol duration Z is equal to the symbol duration Y. That is, the local clock calibration signal can have the same symbol duration as the data symbol duration.

The disclosure relates in some aspects to using 3GPP OOK-1 and OOK-N (e.g., OOK-4) sequences for reader-to-device (R2D) signaling (waveforms).

In OOK-1, one OOK symbol maps to one OFDM symbol. For example, for an ON symbol, a ZC sequence may be used to populate M tones out of the possible 2k tones. In contrast, for an OFF symbol, all zeros are assumed across the tones.

In OOK-N, N (e.g., 4) OOK symbols map to one OFDM symbol. Here, a ZC of length M may be generated. The OOK sequence over the symbol will be oversampled by M/N and multiplied by the ZC. M-FFT will then be taken to the output of the multiplication followed by the OFDM iFFT.

In some examples, OOK-1 is used for the preamble and OOK-4 is used for the data. In other examples, OOK-4 with a chip rate x is used for the preamble and OOK-4 with a chip rate y is used for the data, where y>x. In some examples, x=4 and y=12. Other values may be used in other examples.

The disclosure relates in some aspects to indicating the symbol duration (e.g., chip rate) to be used for transmitting data.

In some examples, the symbol duration may be hard coded. For example, the symbol duration could be band dependent or topology dependent. In some examples, the topology may relate to whether the reader device is a UE or a network entity (e.g., a gNB).

In some examples, the symbol duration may be indicated dynamically (e.g., via the clock calibration part). For example, after detecting the preamble, the following clock calibration signal can indicate the symbol duration for data transmission.

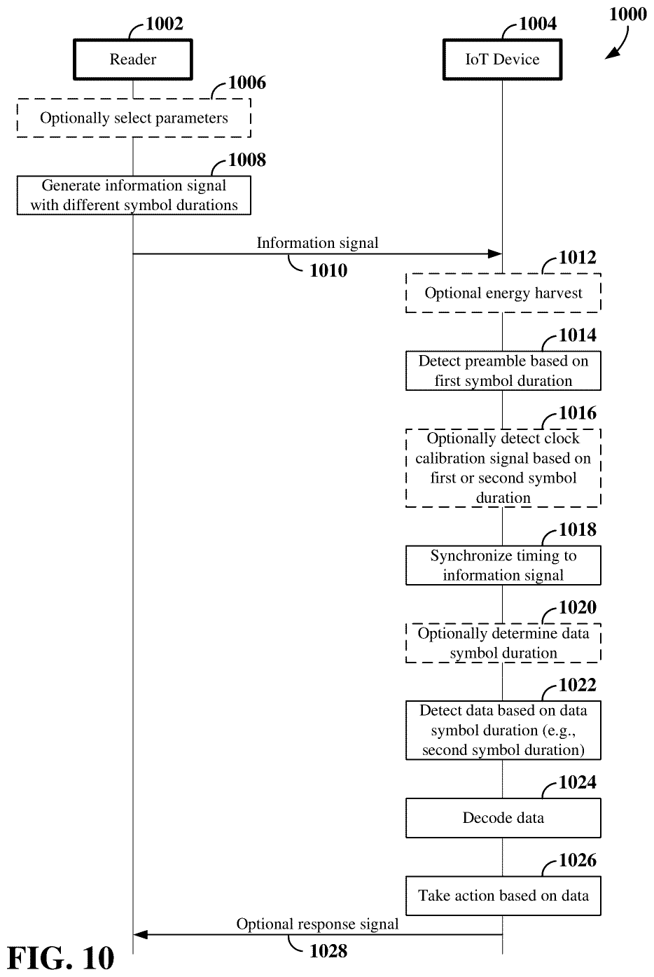

FIG. 10 is a signaling diagram 1000 illustrating an example of signaling in a wireless communication system including a reader 1002 and an IoT device 1004. In some examples, the reader 1002 may correspond to any of the readers, UEs, scheduled entities, network entities, base stations, CUs, DUs, RUs, or scheduling entities shown in any of FIGS. 1-3, 5, 6, and 11. In some examples, the IoT device 1004 may correspond to any of the IoT devices or RFID tags shown in any of FIGS. 1, 2, 5, 6, 7, and 16.

In some examples, some or all of the signaling parameters (e.g., symbol durations, sequences, RF bands, etc.) to be used by the reader 1002 and the IoT device 1004 are predefined. For example, such a parameter may be defined by a communication standard promulgated by a standards body (e.g., 3GPP, IEEE, etc.), configured into a device (e.g., during manufacturing or initial deployment), etc.

In examples where not all of these parameters are predefined, the reader 1002 may select one or more of these parameters as shown at optional #1006 of FIG. 10. For example, the reader 1002 may select a frequency band that is know to be monitored by certain IoT devices.

As another example, the reader 1002 may select a particular symbol duration to be used for transmitting data. As mentioned above, this may involve selecting one of a set of defined symbol durations (e.g., as indicated in a mapping stored in the reader 1002).

In some examples, this selection is based on a mapping of different frequency bands to different symbol durations. Thus, the particular symbol duration to be used for the data may be based on the particular frequency band that is being used for the signaling between the reader 1002 and the IoT device 1004.

In some examples, the selection of the symbol duration is based on a mapping of topologies to different symbol durations. For example, a topology may be based on the type of reader being used (e.g., a UE, a network entity, etc.). Thus, the particular symbol duration to be used for the data may be based on the particular reader topology that is being used.

In some examples, the selection of the symbol duration is based on a mapping of different clock calibration signals (e.g., different clock calibration signal sequences) to different symbol durations. Thus, the particular symbol duration to be used for the data may be based on the particular clock calibration signal sequence that is being used.

At #1008, the reader 1002 generates an information signal. As discussed herein, the information signal includes a preamble and data (e.g., as shown in FIG. 8), where the preamble is generated using a first symbol duration and the data is generated using a second symbol duration.

In some examples, the preamble consists of a defined sequence that is known to (e.g., stored in) the IoT device 1004. In some examples, the preamble consists of an OOK sequence. In some examples, the preamble is an OOK-1 sequence or an OOK-4 sequence.

In some examples, the data includes a query that requests the IoT device 1004 to perform a particular action. For example, the query may request the IoT device to send certain information (e.g., relating to the status of the IoT device 1004, conditions monitored by the IoT device 1004, information received by the IoT device 1004, and so on).

In some examples, the data consists of an OOK sequence. In some examples, the data is an OOK-4 sequence or some other type of sequence.

In some examples, the information signal also includes a clock calibration signal (e.g., as shown in FIG. 9). The reader 1002 generates the clock calibration signal using a symbol duration that may be different from the first symbol duration and/or the second symbol duration.

In some examples, the clock calibration signal may serve to indicate the symbol duration of the data. For example, as discussed above, the use of a particular clock calibration signal (e.g., clock calibration signal sequence) may indicate that the reader 1002 will use a particular symbol duration for the data.

In some examples, the clock calibration signal may carry an indication of the symbol duration of the data. For example, an indication of a particular symbol duration may be included and/or encoded in the clock calibration signal.

In some examples, the clock calibration signal consists of an OOK sequence. In some examples, the clock calibration signal is an OOK-1 sequence or an OOK-4 sequence.

At #1010, the reader 1002 transmits the information signal. For example, the reader 1002 may transmit the signal on a frequency band designated for IoT communication (e.g., a band that the IoT device 1004 is configured to monitor).

At optional #1012, the IoT device 1004 may harvest energy from the preamble of the information signal to activate the IoT device 1004. For example, if the IoT device 1004 is a passive IoT device, the IoT device 1004 may include circuitry to store energy extracted from the preamble into a battery or capacitor.

At #1014, the IoT device 1004 detects the preamble based on the first symbol duration. For example, once the IoT device 1004 is activated, the IoT device 1004 may be configured to monitor for a specific OOK sequence (e.g., OOK-1, OOK-4, etc.) having a specific symbol duration.

At optional #1016, the IoT device 1004 may detect a clock calibration signal. For example, once the preamble is detected, the IoT device 1004 may be configured to monitor for a specific OOK sequence associated with a clock calibration signal. As discussed herein, the clock calibration signal may be transmitted using the same symbol duration as was used for the preamble or some other symbol duration.

At #1018, the IoT device 1004 synchronizes its timing to the information signal. In scenarios where the information signal includes a clock calibration signal, the IoT device 1004 may synchronize the frequency (and, optionally, phase) of its internal clock to the clock calibration signal. Otherwise, the IoT device 1004 may synchronize the frequency (and, optionally, phase) of its internal clock to the preamble.

At optional #1020, the IoT device 1004 may determine the symbol duration used for the data. As discussed above, this may involve identifying one of a set of defined symbol durations (e.g., as indicated in a mapping stored in the IoT device 1004). For example, the particular symbol duration to be used may correspond to the particular frequency band being used for the IoT signaling, a particular topology being used, a particular calibration clock signal being used, and so on. Thus, the IoT device 1004 may compare one or more of these factors with the mapping to identify the symbol duration used for the data. As another example, the IoT device 1004 may decode the calibration clock signal to extract an indicated symbol duration.

At #1022, the IoT device 1004 may detect the data. For example, once the preamble or clock calibration signal is detected, the IoT device 1004 may be configured to monitor for a specific OOK sequence (e.g., OOK-4, etc.) associated with the data. As discussed herein, the data may be transmitted using a different symbol duration than was used for the preamble. Also, the symbol duration used for the data may be the same as or different from the symbol duration used for the clock calibration signal.

At #1024, the IoT device 1004 decodes the data. As discussed above, the data may include a query or some other type of message.

At #1026, the IoT device 1004 takes action based on the decoded data. For example, the IoT device 1004 may generate a response to a query.

At optional #1028, the IoT device 1004 may transmit a response to the reader 1002. As discussed herein, in some examples (e.g., when the IoT device 1004 is a passive IoT device), this response may be transmitted via backscatter signaling.

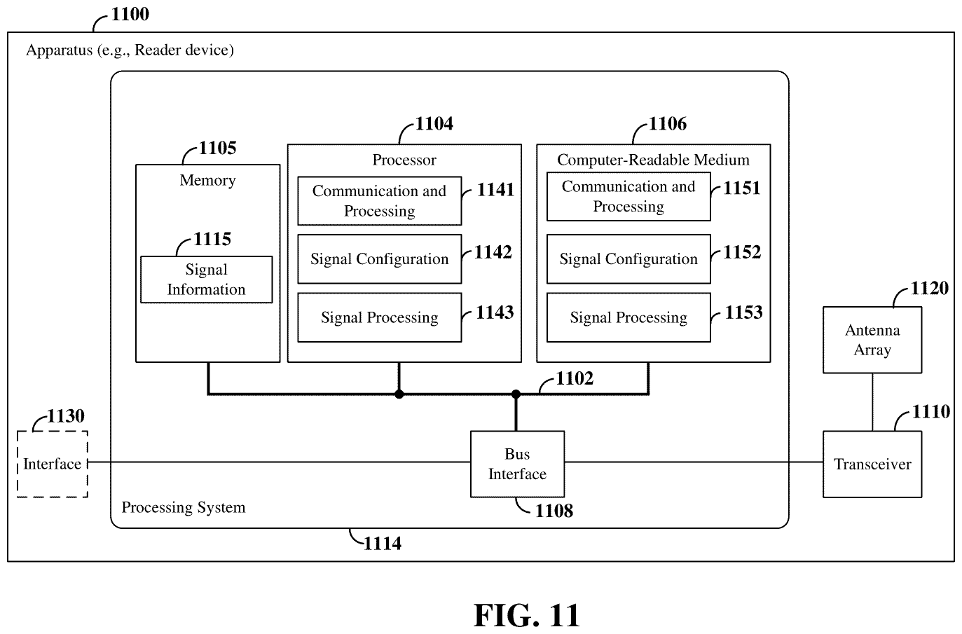

FIG. 11 is a block diagram illustrating an example of a hardware implementation for an apparatus 1100 employing a processing system 1114. The apparatus includes reader functionality (e.g., as described above in conjunction with FIGS. 1-10).

In some implementations, the apparatus 1100 may be a device configured to wirelessly communicate with a network entity, as discussed in any one or more of FIGS. 1-10. For example, the apparatus 1100 may correspond to any of the readers, UEs, or scheduled entities shown in any of FIGS. 1-3, 5, 6, and 10.

In some implementations, the apparatus 1100 may be a network entity. For example, the apparatus 1100 may correspond to any of the readers, base stations, CUs, DUs, RUs, or scheduling entities shown in any of FIGS. 1-3, 5, 6, and 10.

In accordance with various aspects of the disclosure, an element, or any portion of an element, or any combination of elements may be implemented with the processing system 1114. The processing system 1114 may include one or more processors 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1100 may be configured to perform any one or more of the functions described herein. That is, the processor 1104, as utilized in an apparatus 1100, may be used to implement any one or more of the processes and procedures described herein.

The processor 1104 may in some instances be implemented via a baseband or modem chip and in other implementations, the processor 1104 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

The processor 1104 may in some instances be configured to generate, schedule, and modify a resource assignment or grant of time-frequency resources (e.g., a set of one or more resource elements). For example, the processor 1104 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1104 may be configured to schedule resources for the transmission of downlink signals. The processor 1104 may further be configured to schedule resources for the transmission of uplink signals.

The processing system 1114 may be implemented with a bus architecture, represented generally by the bus 1102. The bus 1102 may include any number of interconnecting buses and bridges depending on the specific application of the processing system 1114 and the overall design constraints. The bus 1102 communicatively couples together various circuits including one or more processors (represented generally by the processor 1104), a memory 1105, and computer-readable media (represented generally by the computer-readable medium 1106). The bus 1102 may also link various other circuits such as timing sources, peripherals, voltage regulators, and power management circuits, which are well known in the art, and therefore, will not be described any further. A bus interface 1108 provides an interface between the bus 1102, a transceiver 1110 and an antenna array 1120 and between the bus 1102 and an interface 1130. The transceiver 1110 provides a communication interface or means for communicating with various other apparatus over a wireless transmission medium. The interface 1130 provides a communication interface or means of communicating with various other apparatuses and devices (e.g., other devices housed within the same apparatus as the apparatus 1100 or other external apparatuses) over an internal bus or external transmission medium, such as an Ethernet cable. Depending upon the nature of the apparatus, the interface 1130 may include a user interface (e.g., keypad, display, speaker, microphone, joystick). Of course, such a user interface is optional, and may be omitted in some examples, such as an IoT device.

The processor 1104 is responsible for managing the bus 1102 and general processing, including the execution of software stored on the computer-readable medium 1106. The software, when executed by the processor 1104, causes the processing system 1114 to perform the various functions described below for any particular apparatus. The computer-readable medium 1106 and the memory 1105 may also be used for storing data that is manipulated by the processor 1104 when executing software. For example, the memory 1105 may store signal information 1115 (e.g., symbol duration information, mapping information, and so on) used by the processor 1104 for the communication operations described herein.

One or more processors 1104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1106.

The computer-readable medium 1106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1106 may reside in the processing system 1114, external to the processing system 1114, or distributed across multiple entities including the processing system 1114. The computer-readable medium 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

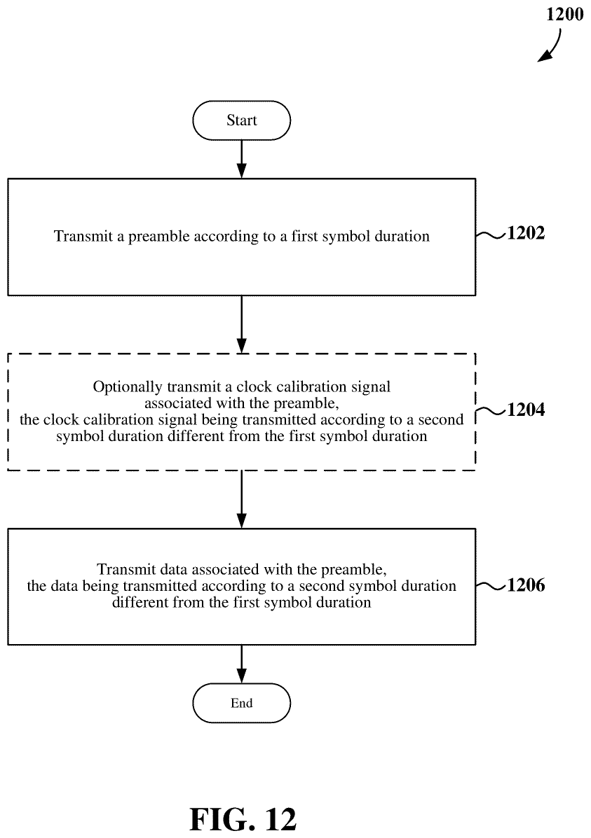

The apparatus 1100 may be configured to perform any one or more of the operations described herein (e.g., as described above in conjunction with FIGS. 1-10 and as described below in conjunction with FIGS. 12-15). In some aspects of the disclosure, the processor 1104, as utilized in the apparatus 1100, may include circuitry configured for various functions.

The processor 1104 may include communication and processing circuitry 1141. The communication and processing circuitry 1141 may include one or more hardware components that provide the physical structure that performs various processes related to wireless communication (e.g., signal reception and/or signal transmission) as described herein. The communication and processing circuitry 1141 may further include one or more hardware components that provide the physical structure that performs various processes related to signal processing (e.g., processing a received signal and/or processing a signal for transmission) as described herein. In some examples, the communication and processing circuitry 1141 may include two or more transmit/receive chains. The communication and processing circuitry 1141 may further be configured to execute communication and processing software 1151 included on the computer-readable medium 1106 to implement one or more functions described herein.

In some examples, the communication and processing circuitry 1141 may be configured to communicate with a network entity, such as a gNB. For example, the communication and processing circuitry 1141 may be configured to communicate with a base station and one or more other wireless communication devices over a common carrier shared between a cellular (e.g., Uu) interface and a sidelink (e.g., PC5) interface. The communication and processing circuitry 1141 may further be configured to send an indication to a network entity or a user equipment. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 1141 may further be configured to send a scheduling request to a network entity for an uplink grant or a sidelink grant.

In some examples, the communication and processing circuitry 1141 may be configured to communicate with a user equipment. For example, the communication and processing circuitry 1141 may be configured to communicate with a user equipment via a cellular (e.g., Uu) interface or a sidelink interface. The communication and processing circuitry 1141 may further be configured to receive an indication from a UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 1141 may further be configured to receive a scheduling request from a UE for an uplink grant or a sidelink grant.

In some implementations where the communication involves receiving information, the communication and processing circuitry 1141 may obtain information from a component of the apparatus 1100 (e.g., from the transceiver 1110 that receives the information via radio frequency signaling or some other type of signaling suitable for the applicable communication medium), process (e.g., decode) the information, and output the processed information. For example, the communication and processing circuitry 1141 may output the information to another component of the processor 1104, to the memory 1105, or to the bus interface 1108. In some examples, the communication and processing circuitry 1141 may receive one or more of signals, messages, other information, or any combination thereof. In some examples, the communication and processing circuitry 1141 may receive information via one or more channels. In some examples, the communication and processing circuitry 1141 may receive one or more of signals, messages, SCIs, feedback, other information, or any combination thereof. In some examples, the communication and processing circuitry 1141 may receive information via one or more of a PSCCH, a PSSCH, a PSFCH, some other type of channel, or any combination thereof. In some examples, the communication and processing circuitry 1141 may include functionality for a means for receiving. In some examples, the communication and processing circuitry 1141 may include functionality for a means for decoding.

In some implementations where the communication involves sending (e.g., transmitting) information, the communication and processing circuitry 1141 may obtain information (e.g., from another component of the processor 1104, the memory 1105, or the bus interface 1108), process (e.g., encode) the information, and output the processed information. For example, the communication and processing circuitry 1141 may output the information to the transceiver 1110 (e.g., that transmits the information via radio frequency signaling or some other type of signaling suitable for the applicable communication medium). In some examples, the communication and processing circuitry 1141 may send one or more of signals, messages, other information, or any combination thereof. In some examples, the communication and processing circuitry 1141 may send information via one or more channels. In some examples, the communication and processing circuitry 1141 may send one or more of signals, messages, SCIs, feedback, other information, or any combination thereof. In some examples, the communication and processing circuitry 1141 may send information via one or more of a PSCCH, a PSSCH, a PSFCH, some other type of channel, or any combination thereof. In some examples, the communication and processing circuitry 1141 may include functionality for a means for transmitting (e.g., transmitting an OFDM transmission). In some examples, the communication and processing circuitry 1141 may include functionality for a means for encoding.

The processor 1104 may include signal configuration circuitry 1142 configured to perform signal configuration-related operations as discussed herein (e.g., one or more of the operations described above in conjunction with FIGS. 1-10). The signal configuration circuitry 1142 may be configured to execute signal configuration software 1152 included on the computer-readable medium 1106 to implement one or more functions described herein.

The signal configuration circuitry 1142 may include functionality for a means for maintaining signal information (e.g., as described above in conjunction with FIGS. 1-10). For example, the signal configuration circuitry 1142 may cooperate with the communication and processing circuitry 1141 to receive a configuration message and store information (e.g., symbol durations, mappings, etc.) from the message in a memory.

The signal configuration circuitry 1142 may include functionality for a means for identifying (e.g., as described above in conjunction with FIGS. 1-10). For example, the signal configuration circuitry 1142 may identify a symbol duration for the transmission of data from a mapping of different symbol durations to different frequency bands. As another example, the signal configuration circuitry 1142 may identify a symbol duration for the transmission of data from a mapping of different symbol durations to different signal sequences. As a further example, the signal configuration circuitry 1142 may identify a symbol duration for the transmission of data from a mapping of different symbol durations to different reader topologies. As yet another example, the signal configuration circuitry 1142 may identify a symbol duration for the transmission of a preamble from a mapping of different symbol durations to different frequency bands.

The processor 1104 may include signal processing circuitry 1143 configured to perform signal processing-related operations as discussed herein (e.g., one or more of the operations described above in conjunction with FIGS. 1-10). The signal processing circuitry 1143 may be configured to execute signal processing software 1153 included on the computer-readable medium 1106 to implement one or more functions described herein.

The signal processing circuitry 1143 may include functionality for a means for transmitting (e.g., as described above in conjunction with FIGS. 1-10). For example, the signal processing circuitry 1143 may cooperate with the communication and processing circuitry 1141 to transmit an information signal to an IoT device. In some examples, the signal processing circuitry 1143 may cooperate with the communication and processing circuitry 1141 to transmit a preamble according to (e.g., using) a first symbol duration. In some examples, the signal processing circuitry 1143 may cooperate with the communication and processing circuitry 1141 to transmit data according to (e.g., using) a second symbol duration. In some examples, the signal processing circuitry 1143 may cooperate with the communication and processing circuitry 1141 to transmit a clock calibration signal. The clock calibration signal may be transmitted according to (e.g., using) the first symbol duration, the second symbol duration, or some other symbol duration.

The signal processing circuitry 1143 may include functionality for a means for receiving (e.g., as described above in conjunction with FIGS. 1-10). For example, the signal processing circuitry 1143 may cooperate with the communication and processing circuitry 1141 to receive information from an IoT device.

The signal processing circuitry 1143 may include functionality for a means for generating data (e.g., as described above in conjunction with FIGS. 1-10). For example, the signal processing circuitry 1143 may generate a query to be sent to an IoT device.

In some examples, the apparatus 1100 shown and described above in connection with FIG. 11 may be a disaggregated base station. For example, the apparatus 1100 shown in FIG. 11 may include the CU and optionally one or more DUs/RUs of the disaggregated base station. Other DUs/RUs associated with the apparatus 1100 may be distributed throughout the network. In some examples, the DUs/RUs may correspond to TRPs associated with the network entity. In some examples, the CU and/or DU/RU of the disaggregated base station (e.g., within the apparatus 1100) may generate information signals and transmit the signals to an IoT device, as well as receive and process messages from the IoT device.

FIG. 12 is a flow chart illustrating an example method 1200 for wireless communication in accordance with some aspects of the present disclosure. As described below, some or all illustrated features may be omitted in a particular implementation within the scope of the present disclosure, and some illustrated features may not be required for implementation of all examples. In some examples, the method 1200 (method for wireless communication) may be carried out by the apparatus 1100 illustrated in FIG. 11. In some examples, the method 1200 may be carried out by any suitable apparatus or means for carrying out the functions or algorithm described below.

At block 1202, an apparatus may transmit a preamble according to a first symbol duration. In some examples, the signal processing circuitry 1143 may provide a means to transmit a preamble according to a first symbol duration. In some examples, the signal processing circuitry 1143 together with the communication and processing circuitry 1141 and the transceiver 1110, shown and described in FIG. 11, may provide a means to transmit a preamble according to a first symbol duration. In some examples, the communication and processing circuitry 1141 and the transceiver 1110, shown and described in FIG. 11, may provide a means to transmit a preamble according to a first symbol duration.

At optional block 1204, the apparatus may transmit a clock calibration signal associated with the preamble, the clock calibration signal being transmitted according to a second symbol duration different from the first symbol duration. In some examples, the signal processing circuitry 1143 may provide a means to transmit a clock calibration signal associated with the preamble, the clock calibration signal being transmitted according to a second symbol duration different from the first symbol duration. In some examples, the signal processing circuitry 1143 together with the communication and processing circuitry 1141 and the transceiver 1110, shown and described in FIG. 11, may provide a means to transmit a clock calibration signal associated with the preamble, the clock calibration signal being transmitted according to a second symbol duration different from the first symbol duration. In some examples, the communication and processing circuitry 1141 and the transceiver 1110, shown and described in FIG. 11, may provide a means to transmit a clock calibration signal associated with the preamble, the clock calibration signal being transmitted according to a second symbol duration different from the first symbol duration.

At block 1206, the apparatus may transmit data associated with the preamble, the data being transmitted according to a second symbol duration different from the first symbol duration. In some examples, the signal processing circuitry 1143 may provide a means to transmit data associated with the preamble, the data being transmitted according to a second symbol duration different from the first symbol duration. In some examples, the signal processing circuitry 1143 together with the communication and processing circuitry 1141 and the transceiver 1110, shown and described in FIG. 11, may provide a means to transmit data associated with the preamble, the data being transmitted according to a second symbol duration different from the first symbol duration. In some examples, the communication and processing circuitry 1141 and the transceiver 1110, shown and described in FIG. 11, may provide a means to transmit data associated with the preamble, the data being transmitted according to a second symbol duration different from the first symbol duration.

In some examples, data associated with the preamble refers to data and a preamble that are transmitted in a common transmission (e.g., as shown in FIG. 8 or FIG. 9, as discussed at #1008 and #1010 of FIG. 10, etc.). In some examples, data associated with the preamble refers to data that is transmitted immediately after a preamble (e.g., as shown in FIG. 8). In some examples, data associated with the preamble refers to data that is transmitted immediately after a clock calibration signal that is transmitted immediately after a preamble (e.g., as shown in FIG. 9).

In some examples, the preamble is defined for communication with an energy harvesting Internet of Things (IoT) device. In some examples, the preamble is defined for communication with an ambient IoT device. In some examples, the preamble is defined for communication with an ambient IoT device.

In some examples, a transmission according to a particular symbol duration refers to a transmission where the symbols being transmitted have a duration that corresponds to (e.g., equals) the particular symbol duration.

In some examples, the apparatus may transmit a clock calibration signal associated with the preamble. In some examples, the apparatus may transmit the clock calibration signal according to the second symbol duration. In some examples, the apparatus may transmit the clock calibration signal according to a third symbol duration different from the first symbol duration and the second symbol duration.

In some examples, a clock calibration signal associated with the preamble refers to a clock calibration signal and a preamble that are transmitted in a common transmission (e.g., as shown in FIG. 9, as discussed at #1008 and #1010 of FIG. 10, etc.). In some examples, a clock calibration signal associated with the preamble refers to a clock calibration signal that is transmitted immediately after a preamble (e.g., as shown in FIG. 9). In some examples, a clock calibration signal includes certain properties (e.g., transitions) that enable a device that receives the clock calibration signal to synchronize to the frequency and/or phase of the clock calibration signal.

In some examples, the first symbol duration corresponds to a first chip rate (e.g., a first orthogonal frequency division multiplexing (OFDM) chip rate). In some examples, the second symbol duration corresponds to a second chip rate (e.g., a second OFDM chip rate) different from the first chip rate. In some examples, a chip rate refers to a number of pulses per second (chips per second).

In some examples, the first symbol duration corresponds to a first quantity of on-off keying (OOK) symbols being mapped to each orthogonal frequency division multiplexing (OFDM) symbol used for the transmission of the preamble. In some examples, the second symbol duration corresponds to a second quantity of OOK symbols being mapped to each OFDM symbol used for the transmission of the data. In some examples, the second quantity is different from the first quantity. In some examples, the first quantity is one (1) and the second quantity is greater than one (1). In some examples, an OOK sequence includes symbols that are ON (e.g., a signal is present) and symbols that are OFF (e.g., no signal is present).

In some examples, the preamble may be an OOK-1 sequence. In some examples, the data may be an OOK-4 sequence.

In some examples, the preamble may be an on-off keying (OOK) sequence associated with a first chip rate. In some examples, the data may be the OOK sequence associated with a second chip rate different from the first chip rate. In some examples, the OOK sequence is an OOK-4 sequence.

In some examples, the second symbol duration is associated with a first frequency band. In some examples, the apparatus may identify the second symbol duration for the transmission of the data from a mapping of different symbol durations to different frequency bands.

In some examples, the first symbol duration is associated with a first frequency band. In some examples, the apparatus may identify the first symbol duration for the transmission of the preamble from a mapping of different symbol durations to different frequency bands.

In some examples, the second symbol duration is associated with a first reader topology. In some examples, the first reader topology may be a user equipment reader. In some examples, the first reader topology may be a network entity reader. In some examples, the apparatus may identify the second symbol duration for the transmission of the data from a mapping of different symbol durations to different reader topologies.

In some examples, the apparatus may transmit a clock calibration signal associated with the preamble, wherein the clock calibration signal indicates the second symbol duration. In some examples, the apparatus may transmit a clock calibration signal associated with the preamble, wherein the clock calibration signal may include an indication of the second symbol duration.

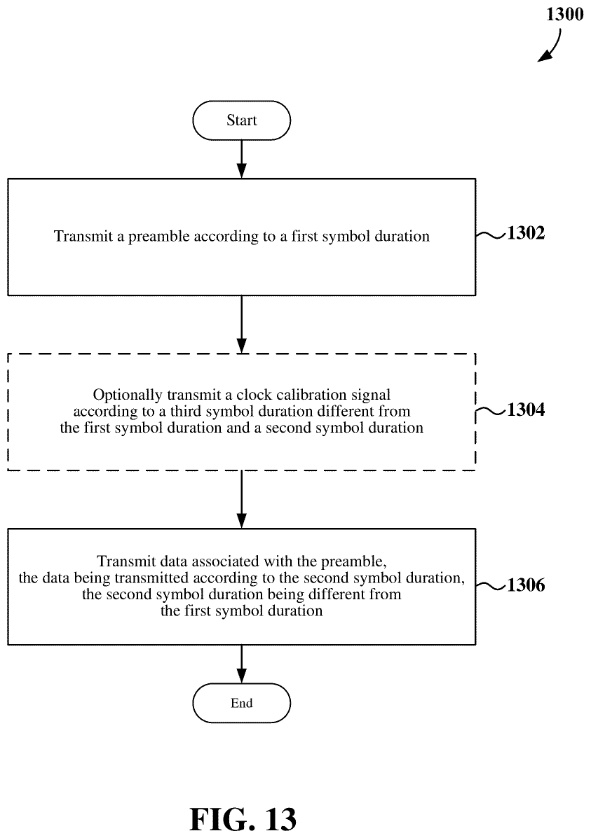

FIG. 13 is a flow chart illustrating an example method 1300 for wireless communication in accordance with some aspects of the present disclosure. As described below, some or all illustrated features may be omitted in a particular implementation within the scope of the present disclosure, and some illustrated features may not be required for implementation of all examples. In some examples, the method 1300 (method for wireless communication) may be carried out by the apparatus 1100 illustrated in FIG. 11. In some examples, the method 1300 may be carried out by any suitable apparatus or means for carrying out the functions or algorithm described below.

At block 1302, an apparatus may transmit a preamble according to a first symbol duration. In some examples, the signal processing circuitry 1143 may provide a means to transmit a preamble according to a first symbol duration. In some examples, the signal processing circuitry 1143 together with the communication and processing circuitry 1141 and the transceiver 1110, shown and described in FIG. 11, may provide a means to transmit a preamble according to a first symbol duration. In some examples, the communication and processing circuitry 1141 and the transceiver 1110, shown and described in FIG. 11, may provide a means to transmit a preamble according to a first symbol duration.

At optional block 1304, the apparatus may transmit a clock calibration signal according to a third symbol duration different from the first symbol duration and a second symbol duration. In some examples, the signal processing circuitry 1143 may provide a means to transmit a clock calibration signal according to a third symbol duration different from the first symbol duration and a second symbol duration. In some examples, the signal processing circuitry 1143 together with the communication and processing circuitry 1141 and the transceiver 1110, shown and described in FIG. 11, may provide a means to transmit a clock calibration signal according to a third symbol duration different from the first symbol duration and a second symbol duration. In some examples, the communication and processing circuitry 1141 and the transceiver 1110, shown and described in FIG. 11, may provide a means to transmit a clock calibration signal according to a third symbol duration different from the first symbol duration and a second symbol duration.

At block 1306, the apparatus may transmit data associated with the preamble, the data being transmitted according to the second symbol duration, the second symbol duration being different from the first symbol duration. In some examples, the signal processing circuitry 1143 may provide a means to transmit data associated with the preamble, the data being transmitted according to the second symbol duration, the second symbol duration being different from the first symbol duration. In some examples, the signal processing circuitry 1143 together with the communication and processing circuitry 1141 and the transceiver 1110, shown and described in FIG. 11, may provide a means to transmit data associated with the preamble, the data being transmitted according to the second symbol duration, the second symbol duration being different from the first symbol duration. In some examples, the communication and processing circuitry 1141 and the transceiver 1110, shown and described in FIG. 11, may provide a means to transmit data associated with the preamble, the data being transmitted according to the second symbol duration, the second symbol duration being different from the first symbol duration.

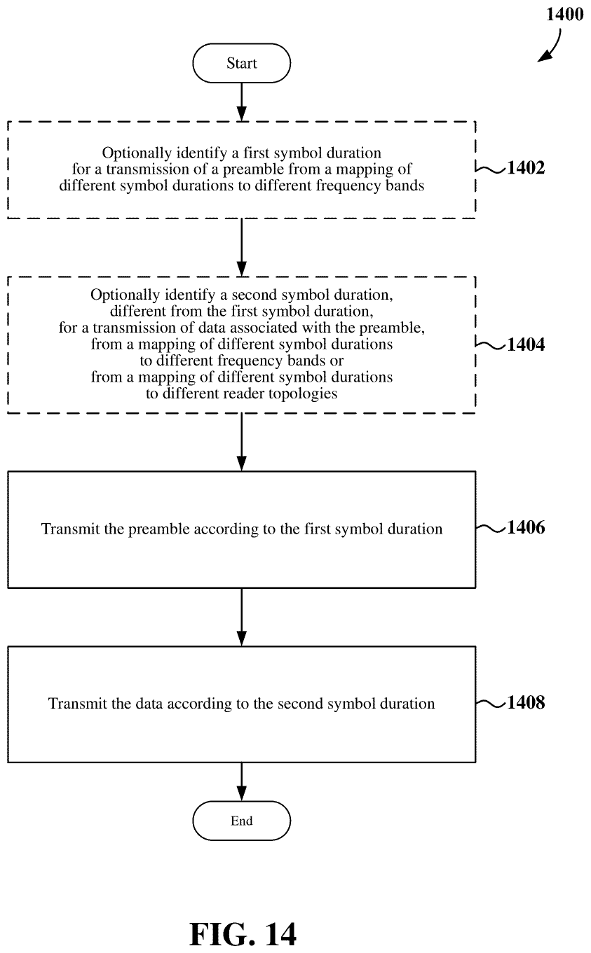

FIG. 14 is a flow chart illustrating an example method 1400 for wireless communication in accordance with some aspects of the present disclosure. As described below, some or all illustrated features may be omitted in a particular implementation within the scope of the present disclosure, and some illustrated features may not be required for implementation of all examples. In some examples, the method 1400 (method for wireless communication) may be carried out by the apparatus 1100 illustrated in FIG. 11. In some examples, the method 1400 may be carried out by any suitable apparatus or means for carrying out the functions or algorithm described below.

At optional block 1402, the apparatus may identify a first symbol duration for a transmission of a preamble from a mapping of different symbol durations to different frequency bands. In some examples, the signal configuration circuitry 1142 may provide a means to identify a first symbol duration for a transmission of a preamble from a mapping of different symbol durations to different frequency bands.

At optional block 1404, the apparatus may identify a second symbol duration, different from the first symbol duration, for a transmission of data associated with the preamble, from a mapping of different symbol durations to different frequency bands or from a mapping of different symbol durations to different reader topologies. In some examples, the signal configuration circuitry 1142 may provide a means to identify a second symbol duration, different from the first symbol duration, for a transmission of data associated with the preamble, from a mapping of different symbol durations to different frequency bands or from a mapping of different symbol durations to different reader topologies.

At block 1406, an apparatus may transmit the preamble according to the first symbol duration. In some examples, the signal processing circuitry 1143 may provide a means to transmit the preamble according to the first symbol duration. In some examples, the signal processing circuitry 1143 together with the communication and processing circuitry 1141 and the transceiver 1110, shown and described in FIG. 11, may provide a means to transmit the preamble according to the first symbol duration. In some examples, the communication and processing circuitry 1141 and the transceiver 1110, shown and described in FIG. 11, may provide a means to transmit the preamble according to the first symbol duration.

At block 1408, the apparatus may transmit the data according to the second symbol duration. In some examples, the signal processing circuitry 1143 may provide a means to transmit the data according to the second symbol duration. In some examples, the signal processing circuitry 1143 together with the communication and processing circuitry 1141 and the transceiver 1110, shown and described in FIG. 11, may provide a means to transmit the data according to the second symbol duration. In some examples, the communication and processing circuitry 1141 and the transceiver 1110, shown and described in FIG. 11, may provide a means to transmit the data according to the second symbol duration.

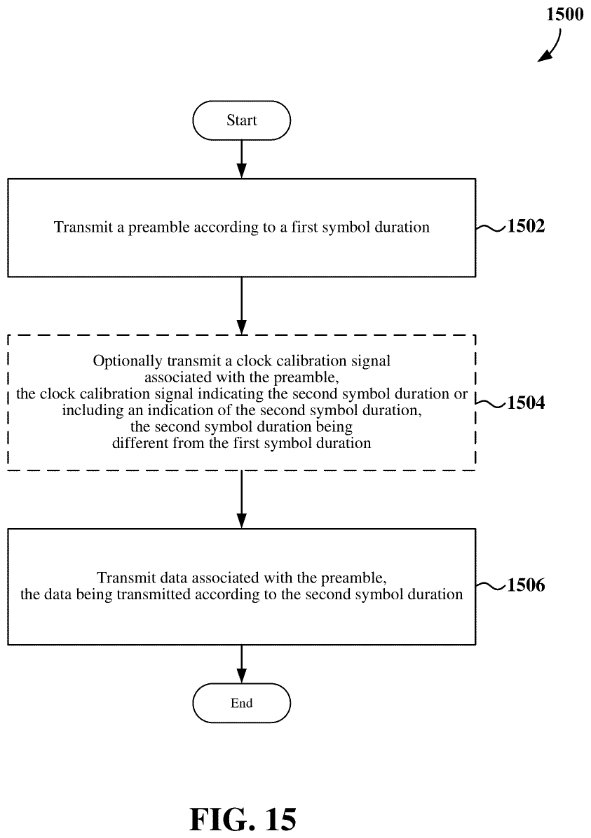

FIG. 15 is a flow chart illustrating an example method 1500 for wireless communication in accordance with some aspects of the present disclosure. As described below, some or all illustrated features may be omitted in a particular implementation within the scope of the present disclosure, and some illustrated features may not be required for implementation of all examples. In some examples, the method 1500 (method for wireless communication) may be carried out by the apparatus 1100 illustrated in FIG. 11. In some examples, the method 1500 may be carried out by any suitable apparatus or means for carrying out the functions or algorithm described below.

At block 1502, an apparatus may transmit a preamble according to a first symbol duration. In some examples, the signal processing circuitry 1143 may provide a means to transmit a preamble according to a first symbol duration. In some examples, the signal processing circuitry 1143 together with the communication and processing circuitry 1141 and the transceiver 1110, shown and described in FIG. 11, may provide a means to transmit a preamble according to a first symbol duration. In some examples, the communication and processing circuitry 1141 and the transceiver 1110, shown and described in FIG. 11, may provide a means to transmit a preamble according to a first symbol duration.

At optional block 1504, the apparatus may transmit a clock calibration signal associated with the preamble, the clock calibration signal indicating the second symbol duration or including an indication of the second symbol duration, the second symbol duration being different from the first symbol duration. In some examples, the signal processing circuitry 1143 may provide a means to transmit a clock calibration signal associated with the preamble, the clock calibration signal indicating the second symbol duration or including an indication of the second symbol duration, the second symbol duration being different from the first symbol duration. In some examples, the signal processing circuitry 1143 together with the communication and processing circuitry 1141 and the transceiver 1110, shown and described in FIG. 11, may provide a means to transmit a clock calibration signal associated with the preamble, the clock calibration signal indicating the second symbol duration or including an indication of the second symbol duration, the second symbol duration being different from the first symbol duration. In some examples, the communication and processing circuitry 1141 and the transceiver 1110, shown and described in FIG. 11, may provide a means to transmit a clock calibration signal associated with the preamble, the clock calibration signal indicating the second symbol duration or including an indication of the second symbol duration, the second symbol duration being different from the first symbol duration.

At block 1506, the apparatus may transmit data associated with the preamble, the data being transmitted according to the second symbol duration. In some examples, the signal processing circuitry 1143 may provide a means to transmit data associated with the preamble, the data being transmitted according to the second symbol duration. In some examples, the signal processing circuitry 1143 together with the communication and processing circuitry 1141 and the transceiver 1110, shown and described in FIG. 11, may provide a means to transmit data associated with the preamble, the data being transmitted according to the second symbol duration. In some examples, the communication and processing circuitry 1141 and the transceiver 1110, shown and described in FIG. 11, may provide a means to transmit data associated with the preamble, the data being transmitted according to the second symbol duration.

Referring again to FIG. 11, in one configuration, the apparatus 1100 includes means for transmitting a preamble according to a first symbol duration, and means for transmitting data associated with the preamble, the data being transmitted according to a second symbol duration different from the first symbol duration. In one aspect, the aforementioned means may be the processor 1104 shown in FIG. 11 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1104 is merely provided as an example, and other means for carrying out the described functions may be included within various aspects of the present disclosure, including but not limited to the instructions stored in the computer-readable medium 1106, or any other suitable apparatus or means described in any one or more of FIGS. 1-3, 5, 6, 10, and 11, and utilizing, for example, the methods and/or algorithms described herein in relation to FIGS. 12-15.

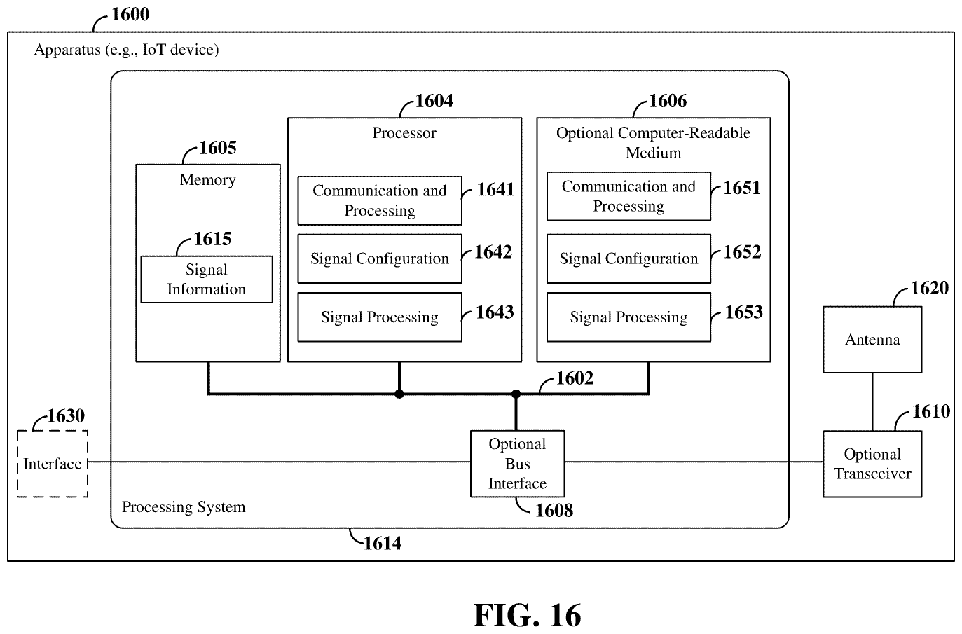

FIG. 16 is a conceptual diagram illustrating an example of a hardware implementation for an apparatus 1600 employing a processing system 1614. The apparatus includes IoT device functionality (e.g., as described above in conjunction with FIGS. 1-10). In some examples, the apparatus is an IoT device (e.g., an ambient IoT device). In some examples, the apparatus 1600 may correspond to any of the IoT devices or RFID tags shown in any of FIGS. 1, 2, 5, 6, 7, and 10.

In accordance with various aspects of the disclosure, an element, or any portion of an element, or any combination of elements may be implemented with the processing system 1614. The processing system 1614 may include one or more processors 1604.

In some implementations (e.g., for a passive IoT device), the apparatus 1600 may include relatively limited processing and communication functionality. For example, in this case, the apparatus 1600 may include an antenna 1620, energy harvesting circuitry (e.g., as described above in conjunction with FIG. 5), detection circuitry (e.g., as described above in conjunction with FIG. 6) and/or a processing system 1614 (e.g., as described above in conjunction with FIG. 5), and backscatter circuitry (e.g., as described above in conjunction with FIG. 5).

In some implementations (e.g., for a semi-passive or active IoT device), the processing system 1614 may include additional processing and communication functionality. For example, in this case, the processing system 1614 may be substantially the same as the processing system 1114 illustrated in FIG. 11, including a bus interface 1608, a bus 1602, memory 1605, a processor 1604, and a computer-readable medium 1606. In addition, the apparatus may include a transceiver 1610, an antenna array, and an interface 1630 (e.g., a network interface) that provides a means for communicating with at least one other apparatus.

The memory 1605 may store signal information 1615 used by the processor 1604 for communication operations as described herein. The signal information 1615 may include symbol duration information, mapping information, and so on.

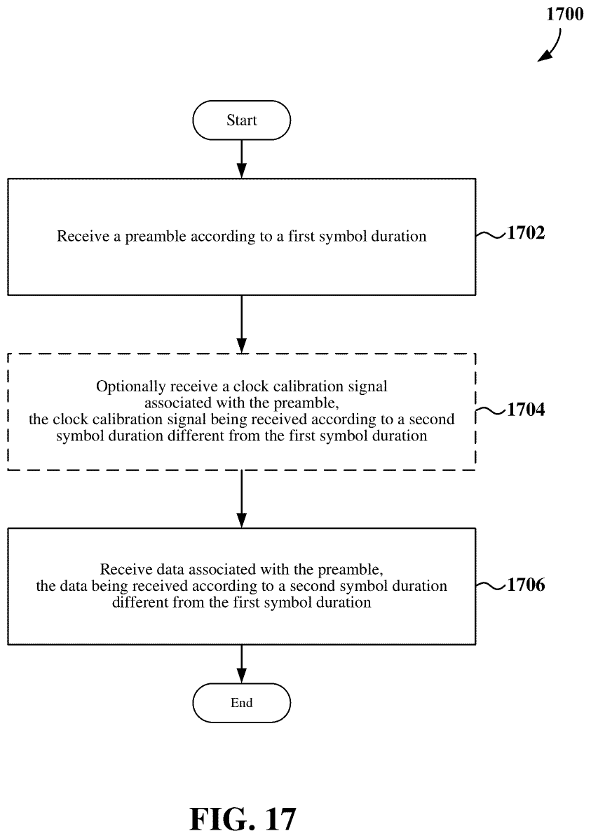

The apparatus 1600 may be configured to perform any one or more of the operations described herein (e.g., as described above in conjunction with FIGS. 1-10 and as described below in conjunction with FIGS. 17-20). In some aspects of the disclosure, the processor 1604, as utilized in the apparatus 1600, may include circuitry configured for various functions.

The processor 1604 may be configured to decode received signals to extract data (e.g., requests) received from a reader. The processor 1604 also may be configured to cause information to be transmitted back to the reader (e.g., via a backscatter signal).

In some examples, the processor 1604 may include communication and processing circuitry 1641. The communication and processing circuitry 1641 may be configured to communicate with a reader and, optionally, other devices. The communication and processing circuitry 1641 may include one or more hardware components that provide the physical structure that performs various processes related to communication (e.g., signal reception and/or signal transmission) as described herein. The communication and processing circuitry 1641 may further include one or more hardware components that provide the physical structure that performs various processes related to signal processing (e.g., processing a received signal and/or processing a signal for transmission) as described herein. The communication and processing circuitry 1641 may further be configured to execute communication and processing software 1651 included on the computer-readable medium 1606 to implement one or more functions described herein.

In some implementations wherein the communication involves receiving information, the communication and processing circuitry 1641 may obtain information from a component of the apparatus 1600 (e.g., from the transceiver 1610 that receives the information via radio frequency signaling or some other type of signaling suitable for the applicable communication medium), process (e.g., decode) the information, and output the processed information. For example, the communication and processing circuitry 1641 may output the information to another component of the processor 1604, to the memory 1605, or to the bus interface 1608. In some examples, the communication and processing circuitry 1641 may receive one or more of signals, messages, other information, or any combination thereof. In some examples, the communication and processing circuitry 1641 may receive information via one or more channels. In some examples, the communication and processing circuitry 1641 may include functionality for a means for receiving (e.g., receiving an information signal). In some examples, the communication and processing circuitry 1641 may include functionality for a means for decoding.

In some implementations wherein the communication involves sending (e.g., transmitting) information, the communication and processing circuitry 1641 may obtain information (e.g., from another component of the processor 1604, the memory 1605, or the bus interface 1608), process (e.g., encode) the information, and output the processed information. For example, the communication and processing circuitry 1641 may output the information to the transceiver 1610 (e.g., that transmits the information via radio frequency signaling or some other type of signaling suitable for the applicable communication medium). In some examples, the communication and processing circuitry 1641 may send one or more of signals, messages, other information, or any combination thereof. In some examples, the communication and processing circuitry 1641 may send information via one or more channels. In some examples, the communication and processing circuitry 1641 may include functionality for a means for transmitting (e.g., transmitting information). In some examples, the communication and processing circuitry 1641 may include functionality for a means for encoding.

The processor 1604 may include signal configuration circuitry 1642 configured to perform signal configuration-related operations as discussed herein (e.g., one or more of the operations described above in conjunction with FIGS. 1-10). The signal configuration circuitry 1642 may be configured to execute signal configuration software 1652 included on the computer-readable medium 1606 to implement one or more functions described

The signal configuration circuitry 1642 may include functionality for a means for maintaining information (e.g., as described above in conjunction with FIGS. 1-10). For example, the signal configuration circuitry 1642 may cooperate with the communication and processing circuitry 1641 to receive a configuration message and store information (e.g., symbol durations, mappings, etc.) from the message in a memory.

The signal configuration circuitry 1642 may include functionality for a means for identifying (e.g., as described above in conjunction with FIGS. 1-10). For example, the signal configuration circuitry 1642 may identify a symbol duration for the reception of data from a mapping of different symbol durations to different frequency bands. As another example, the signal configuration circuitry 1642 may identify a symbol duration for the reception of data from a mapping of different symbol durations to different signal sequences. As a further example, the signal configuration circuitry 1642 may identify a symbol duration for the reception of data from a mapping of different symbol durations to different reader topologies. As yet another example, the signal configuration circuitry 1642 may identify a symbol duration for the reception of a preamble from a mapping of different symbol durations to different frequency bands.

The processor 1604 may include signal processing circuitry 1643 configured to perform signal processing-related operations as discussed herein (e.g., one or more of the operations described above in conjunction with FIGS. 1-10). The signal processing circuitry 1643 may be configured to execute signal processing software 1653 included on the computer-readable medium 1606 to implement one or more functions described herein.

The signal processing circuitry 1643 may include functionality for a means for receiving (e.g., as described above in conjunction with FIGS. 1-10). For example, the signal processing circuitry 1643 may cooperate with the communication and processing circuitry 1641 to receive an information signal from a reader. In some examples, the signal processing circuitry 1643 may cooperate with the communication and processing circuitry 1641 to receive a preamble according to (e.g., using) a first symbol duration. In some examples, the signal processing circuitry 1643 may cooperate with the communication and processing circuitry 1641 to receive data according to (e.g., using) a second symbol duration. In some examples, the signal processing circuitry 1643 may cooperate with the communication and processing circuitry 1641 to receive a clock calibration signal. The clock calibration signal may be received according to (e.g., using) the first symbol duration, the second symbol duration, or some other symbol duration.

The signal processing circuitry 1643 may include functionality for a means for processing data (e.g., as described above in conjunction with FIGS. 1-10). For example, the signal processing circuitry 1643 may decode data sent by a reader.

The signal processing circuitry 1643 may include functionality for a means for invoking an action (e.g., as described above in conjunction with FIGS. 1-10). For example, the signal processing circuitry 1643 may invoke an action in response to a request sent by a reader.

The signal processing circuitry 1643 may include functionality for a means for transmitting (e.g., as described above in conjunction with FIGS. 1-10). For example, the signal processing circuitry 1643 may cooperate with the communication and processing circuitry 1641 to transmit information (e.g., a response) to a reader.

FIG. 17 is a flow chart illustrating an example method 1700 for wireless communication in accordance with some aspects of the present disclosure. As described below, some or all illustrated features may be omitted in a particular implementation within the scope of the present disclosure, and some illustrated features may not be required for implementation of all examples. In some examples, the method 1700 may be carried out by the apparatus 1600 illustrated in FIG. 16. In some examples, the method 1700 may be carried out by any suitable apparatus or means for carrying out the functions or algorithm described below.

At block 1702, an apparatus may receive a preamble according to a first symbol duration. In some examples, the signal processing circuitry 1643 may provide a means to receive a preamble according to a first symbol duration. In some examples, the signal processing circuitry 1643 together with the communication and processing circuitry 1641 and the transceiver 1610, shown and described in FIG. 16, may provide a means to receive a preamble according to a first symbol duration. In some examples, the communication and processing circuitry 1641 and the transceiver 1610, shown and described in FIG. 16, may provide a means to receive a preamble according to a first symbol duration.

At optional block 1704, the apparatus may receive a clock calibration signal associated with the preamble, the clock calibration signal being received according to a second symbol duration different from the first symbol duration. In some examples, the signal processing circuitry 1643 may provide a means to receive a clock calibration signal associated with the preamble, the clock calibration signal being received according to a second symbol duration different from the first symbol duration. In some examples, the signal processing circuitry 1643 together with the communication and processing circuitry 1641 and the transceiver 1610, shown and described in FIG. 16, may provide a means to receive a clock calibration signal associated with the preamble, the clock calibration signal being received according to a second symbol duration different from the first symbol duration. In some examples, the communication and processing circuitry 1641 and the transceiver 1610, shown and described in FIG. 16, may provide a means to receive a clock calibration signal associated with the preamble, the clock calibration signal being received according to a second symbol duration different from the first symbol duration.

At block 1706, the apparatus may receive data associated with the preamble, the data being received according to a second symbol duration different from the first symbol duration. In some examples, the signal processing circuitry 1643 may provide a means to receive data associated with the preamble, the data being received according to a second symbol duration different from the first symbol duration. In some examples, the signal processing circuitry 1643 together with the communication and processing circuitry 1641 and the transceiver 1610, shown and described in FIG. 16, may provide a means to receive data associated with the preamble, the data being received according to a second symbol duration different from the first symbol duration. In some examples, the communication and processing circuitry 1641 and the transceiver 1610, shown and described in FIG. 16, may provide a means to receive data associated with the preamble, the data being received according to a second symbol duration different from the first symbol duration.

In some examples, data associated with the preamble refers to data and a preamble that are received via a common transmission (e.g., as shown in FIG. 8 or FIG. 9, as discussed at #1008 and #1010 of FIG. 10, etc.). In some examples, data associated with the preamble refers to data that is received immediately after a preamble (e.g., as shown in FIG. 8). In some examples, data associated with the preamble refers to data that is received immediately after a clock calibration signal that is received immediately after a preamble (e.g., as shown in FIG. 9).

In some examples, the preamble is defined for communication with an energy harvesting Internet of Things (IoT) device. In some examples, the preamble is defined for communication with an ambient IoT device.

In some examples, a reception according to a particular symbol duration refers to a reception where the symbols being received have a duration that corresponds to (e.g., equals) the particular symbol duration.

In some examples, the apparatus may receive a clock calibration signal associated with the preamble. In some examples, the apparatus may receive the clock calibration signal according to the second symbol duration. In some examples, the apparatus may receive the clock calibration signal according to a third symbol duration different from the first symbol duration and the second symbol duration.

In some examples, a clock calibration signal associated with the preamble refers to a clock calibration signal and a preamble that are transmitted in a common transmission (e.g., as shown in FIG. 9, as discussed at #1008 and #1010 of FIG. 10, etc.). In some examples, a clock calibration signal associated with the preamble refers to a clock calibration signal that is transmitted immediately after a preamble (e.g., as shown in FIG. 9). In some examples, a clock calibration signal includes certain properties (e.g., transitions) that enable a device that receives the clock calibration signal to synchronize to the frequency and/or phase of the clock calibration signal.

In some examples, the first symbol duration corresponds to a first chip rate (e.g., a first orthogonal frequency division multiplexing (OFDM) chip rate). In some examples, the second symbol duration corresponds to a second chip rate (e.g., a second OFDM chip rate) different from the first chip rate. In some examples, a chip rate refers to a number of pulses per second (chips per second).

In some examples, the first symbol duration corresponds to a first quantity of on-off keying (OOK) symbols being mapped to each orthogonal frequency division multiplexing (OFDM) symbol used for the reception of the preamble. In some examples, the second symbol duration corresponds to a second quantity of OOK symbols being mapped to each OFDM symbol used for the reception of the data. In some examples, the second quantity is different from the first quantity. In some examples, the first quantity is one (1) and the second quantity is greater than one (1). In some examples, an OOK sequence includes symbols that are ON (e.g., a signal is present) and symbols that are OFF (e.g., no signal is present).

In some examples, the preamble may be an OOK-1 sequence. In some examples, the data may be an OOK-4 sequence.

In some examples, the preamble may be an on-off keying (OOK) sequence associated with a first chip rate. In some examples, the data may be the OOK sequence associated with a second chip rate different from the first chip rate. In some examples, the OOK sequence is an OOK-4 sequence. In some examples, a chip rate refers to a number of pulses per second (chips per second).

In some examples, the second symbol duration is associated with a first frequency band. In some examples, the apparatus may identify the second symbol duration for the reception of the data from a mapping of different symbol durations to different frequency bands.

In some examples, the first symbol duration is associated with a first frequency band. In some examples, the apparatus may identify the first symbol duration for the reception of the preamble from a mapping of different symbol durations to different frequency bands.

In some examples, the second symbol duration is associated with a first reader topology. In some examples, the first reader topology may be a user equipment reader. In some examples, the first reader topology may be a network entity reader. In some examples, the apparatus may identify the second symbol duration for the reception of the data from a mapping of different symbol durations to different reader topologies.

In some examples, the apparatus may receive a clock calibration signal associated with the preamble, wherein the clock calibration signal indicates the second symbol duration. In some examples, the apparatus may receive a clock calibration signal associated with the preamble, wherein the clock calibration signal may include an indication of the second symbol duration.

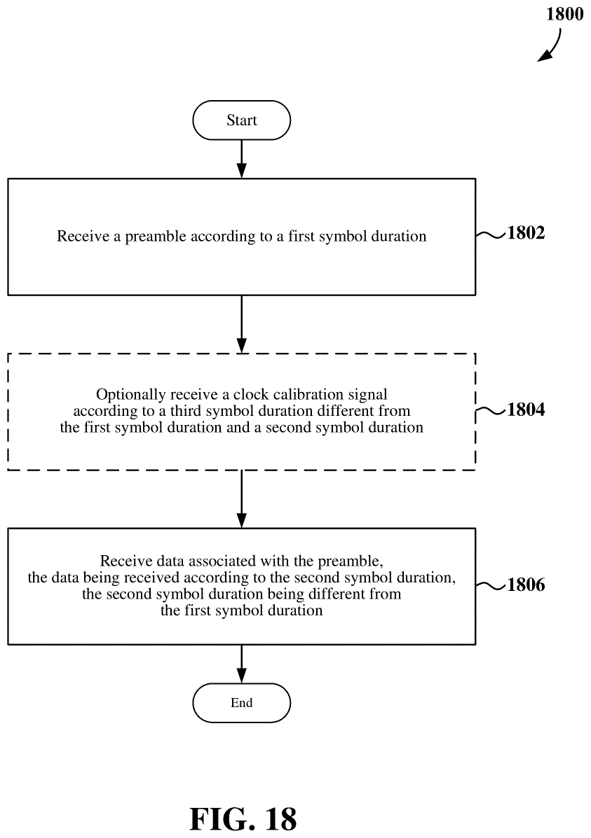

FIG. 18 is a flow chart illustrating an example method 1800 for wireless communication in accordance with some aspects of the present disclosure. As described below, some or all illustrated features may be omitted in a particular implementation within the scope of the present disclosure, and some illustrated features may not be required for implementation of all examples. In some examples, the method 1800 (method for wireless communication) may be carried out by the apparatus 1600 illustrated in FIG. 16. In some examples, the method 1800 may be carried out by any suitable apparatus or means for carrying out the functions or algorithm described below.

At block 1802, an apparatus may receive a preamble according to a first symbol duration. In some examples, the signal processing circuitry 1643 may provide a means to receive a preamble according to a first symbol duration. In some examples, the signal processing circuitry 1643 together with the communication and processing circuitry 1641 and the transceiver 1610, shown and described in FIG. 16, may provide a means to receive a preamble according to a first symbol duration. In some examples, the communication and processing circuitry 1641 and the transceiver 1610, shown and described in FIG. 16, may provide a means to receive a preamble according to a first symbol duration.

At optional block 1804, the apparatus may receive a clock calibration signal according to a third symbol duration different from the first symbol duration and a second symbol duration. In some examples, the signal processing circuitry 1643 may provide a means to receive a clock calibration signal according to a third symbol duration different from the first symbol duration and a second symbol duration. In some examples, the signal processing circuitry 1643 together with the communication and processing circuitry 1641 and the transceiver 1610, shown and described in FIG. 16, may provide a means to receive a clock calibration signal according to a third symbol duration different from the first symbol duration and a second symbol duration. In some examples, the communication and processing circuitry 1641 and the transceiver 1610, shown and described in FIG. 16, may provide a means to receive a clock calibration signal according to a third symbol duration different from the first symbol duration and a second symbol duration.

At block 1806, the apparatus may receive data associated with the preamble, the data being received according to the second symbol duration, the second symbol duration being different from the first symbol duration. In some examples, the signal processing circuitry 1643 may provide a means to receive data associated with the preamble, the data being received according to the second symbol duration, the second symbol duration being different from the first symbol duration. In some examples, the signal processing circuitry 1643 together with the communication and processing circuitry 1641 and the transceiver 1610, shown and described in FIG. 16, may provide a means to receive data associated with the preamble, the data being received according to the second symbol duration, the second symbol duration being different from the first symbol duration. In some examples, the communication and processing circuitry 1641 and the transceiver 1610, shown and described in FIG. 16, may provide a means to receive data associated with the preamble, the data being received according to the second symbol duration, the second symbol duration being different from the first symbol duration.

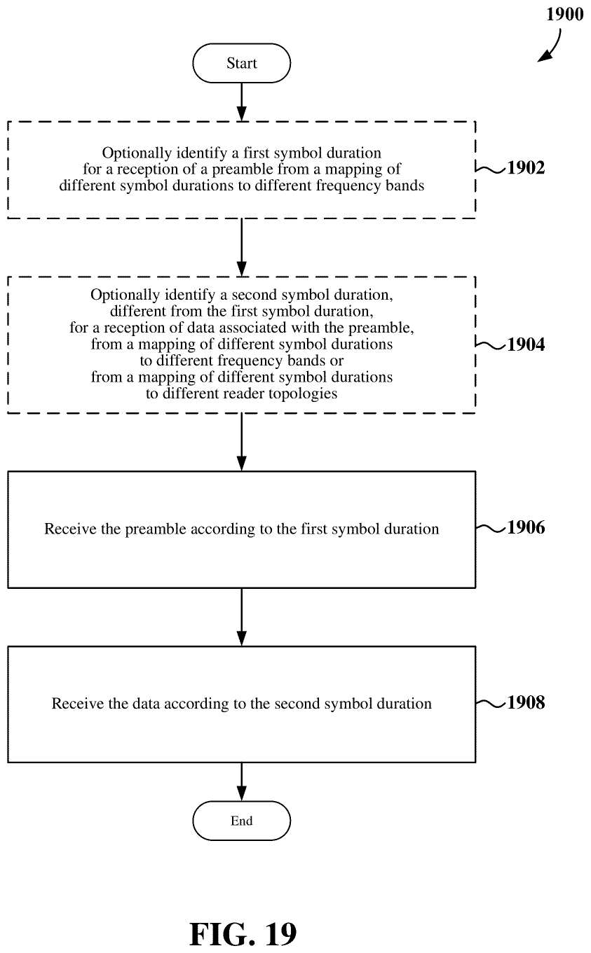

FIG. 19 is a flow chart illustrating an example method 1900 for wireless communication in accordance with some aspects of the present disclosure. As described below, some or all illustrated features may be omitted in a particular implementation within the scope of the present disclosure, and some illustrated features may not be required for implementation of all examples. In some examples, the method 1900 (method for wireless communication) may be carried out by the apparatus 1600 illustrated in FIG. 16. In some examples, the method 1900 may be carried out by any suitable apparatus or means for carrying out the functions or algorithm described below.

At optional block 1902, the apparatus may identify a first symbol duration for a reception of a preamble from a mapping of different symbol durations to different frequency bands. In some examples, the signal configuration circuitry 1642 may provide a means to identify a first symbol duration for a reception of a preamble from a mapping of different symbol durations to different frequency bands.

At optional block 1904, the apparatus may identify a second symbol duration, different from the first symbol duration, for a reception of data associated with the preamble, from a mapping of different symbol durations to different frequency bands or from a mapping of different symbol durations to different reader topologies. In some examples, the signal configuration circuitry 1642 may provide a means to identify a second symbol duration, different from the first symbol duration, for a reception of data associated with the preamble, from a mapping of different symbol durations to different frequency bands or from a mapping of different symbol durations to different reader topologies.

At block 1906, an apparatus may receive the preamble according to the first symbol duration. In some examples, the signal processing circuitry 1643 may provide a means to receive the preamble according to the first symbol duration. In some examples, the signal processing circuitry 1643 together with the communication and processing circuitry 1641 and the transceiver 1610, shown and described in FIG. 16, may provide a means to receive the preamble according to the first symbol duration. In some examples, the communication and processing circuitry 1641 and the transceiver 1610, shown and described in FIG. 16, may provide a means to receive the preamble according to the first symbol duration.

At block 1908, the apparatus may receive the data according to the second symbol duration. In some examples, the signal processing circuitry 1643 may provide a means to receive the data according to the second symbol duration. In some examples, the signal processing circuitry 1643 together with the communication and processing circuitry 1641 and the transceiver 1610, shown and described in FIG. 16, may provide a means to receive the data according to the second symbol duration. In some examples, the communication and processing circuitry 1641 and the transceiver 1610, shown and described in FIG. 16, may provide a means to receive the data according to the second symbol duration.

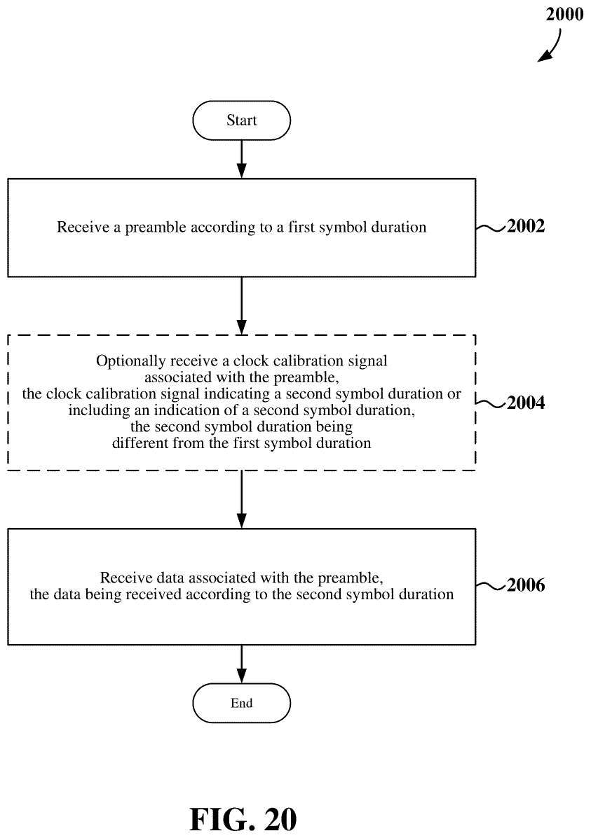

FIG. 20 is a flow chart illustrating an example method 2000 for wireless communication in accordance with some aspects of the present disclosure. As described below, some or all illustrated features may be omitted in a particular implementation within the scope of the present disclosure, and some illustrated features may not be required for implementation of all examples. In some examples, the method 2000 (method for wireless communication) may be carried out by the apparatus 1600 illustrated in FIG. 16. In some examples, the method 2000 may be carried out by any suitable apparatus or means for carrying out the functions or algorithm described below.

At block 2002, an apparatus may receive a preamble according to a first symbol duration. In some examples, the signal processing circuitry 1643 may provide a means to receive a preamble according to a first symbol duration. In some examples, the signal processing circuitry 1643 together with the communication and processing circuitry 1641 and the transceiver 1610, shown and described in FIG. 16, may provide a means to receive a preamble according to a first symbol duration. In some examples, the communication and processing circuitry 1641 and the transceiver 1610, shown and described in FIG. 16, may provide a means to receive a preamble according to a first symbol duration.

At optional block 2004, the apparatus may receive a clock calibration signal associated with the preamble, the clock calibration signal indicating the second symbol duration or including an indication of the second symbol duration, the second symbol duration being different from the first symbol duration. In some examples, the signal processing circuitry 1643 may provide a means to receive a clock calibration signal associated with the preamble, the clock calibration signal indicating the second symbol duration or including an indication of the second symbol duration, the second symbol duration being different from the first symbol duration. In some examples, the signal processing circuitry 1643 together with the communication and processing circuitry 1641 and the transceiver 1610, shown and described in FIG. 16, may provide a means to receive a clock calibration signal associated with the preamble, the clock calibration signal indicating the second symbol duration or including an indication of the second symbol duration, the second symbol duration being different from the first symbol duration. In some examples, the communication and processing circuitry 1641 and the transceiver 1610, shown and described in FIG. 16, may provide a means to receive a clock calibration signal associated with the preamble, the clock calibration signal indicating the second symbol duration or including an indication of the second symbol duration, the second symbol duration being different from the first symbol duration.

At block 2006, the apparatus may receive data associated with the preamble, the data being received according to the second symbol duration. In some examples, the signal processing circuitry 1643 may provide a means to receive data associated with the preamble, the data being received according to the second symbol duration. In some examples, the signal processing circuitry 1643 together with the communication and processing circuitry 1641 and the transceiver 1610, shown and described in FIG. 16, may provide a means to receive data associated with the preamble, the data being received according to the second symbol duration. In some examples, the communication and processing circuitry 1641 and the transceiver 1610, shown and described in FIG. 16, may provide a means to receive data associated with the preamble, the data being received according to the second symbol duration.

Referring again to FIG. 16, in one configuration, the apparatus 1600 includes means for receiving a preamble according to a first symbol duration, and means for receiving data associated with the preamble, the data being received according to a second symbol duration different from the first symbol duration. In one aspect, the aforementioned means may be the processor 1604 shown in FIG. 16 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable medium 1606, or any other suitable apparatus or means described in any one or more of FIGS. 1-3, 5, 6, 7, 10, and 16, and utilizing, for example, the methods and/or algorithms described herein in relation to FIGS. 17-20.

The methods shown in FIGS. 12-15 and 17-20 may include additional aspects, such as any single aspect or any combination of aspects described below and/or in connection with one or more other processes described elsewhere herein. The following provides an overview of several aspects of the present disclosure.

Aspect 1: A method for wireless communication at an apparatus, the method comprising: transmitting a preamble according to a first symbol duration; and transmitting data associated with the preamble, the data being transmitted according to a second symbol duration different from the first symbol duration.

Aspect 2: The method of aspect 1, further comprising: transmitting a clock calibration signal associated with the preamble.

Aspect 3: The method of aspect 2, further comprising: transmitting the clock calibration signal according to the second symbol duration.

Aspect 4: The method of aspect 2, further comprising: transmitting the clock calibration signal according to a third symbol duration different from the first symbol duration and the second symbol duration.

Aspect 5: The method of any of aspects 1 through 4, wherein: the first symbol duration corresponds to a first orthogonal frequency division multiplexing (OFDM) chip rate; and the second symbol duration corresponds to a second OFDM chip rate different from the first OFDM chip rate.

Aspect 6: The method of any of aspects 1 through 5, wherein: the first symbol duration corresponds to a first quantity of on-off keying (OOK) symbols being mapped to each orthogonal frequency division multiplexing (OFDM) symbol used for the transmission of the preamble; the second symbol duration corresponds to a second quantity of OOK symbols being mapped to each OFDM symbol used for the transmission of the data; and the second quantity is different from the first quantity.

Aspect 7: The method of aspect 6, wherein: the first quantity is one; and the second quantity is greater than one.

Aspect 8: The method of any of aspects 1 through 7, wherein: the preamble comprises an OOK-1 sequence; and the data comprises an OOK-4 sequence.

Aspect 9: The method of any of aspects 1 through 8, wherein: the preamble comprises an on-off keying (OOK) sequence associated with a first chip rate; and the data comprises the OOK sequence associated with a second chip rate different from the first chip rate.

Aspect 10: The method of aspect 9, wherein the OOK sequence is an OOK-4 sequence.

Aspect 11: The method of any of aspects 1 through 10, wherein the second symbol duration is associated with a first frequency band.

Aspect 12: The method of any of aspects 1 through 11, further comprising: identifying the second symbol duration for the transmission of the data from a mapping of different symbol durations to different frequency bands.

Aspect 13: The method of any of aspects 1 through 12, wherein the first symbol duration is associated with a first frequency band.

Aspect 14: The method of any of aspects 1 through 13, further comprising: identifying the first symbol duration for the transmission of the preamble from a mapping of different symbol durations to different frequency bands.

Aspect 15: The method of any of aspects 1 through 14, wherein the second symbol duration is associated with a first reader topology.

Aspect 16: The method of aspect 15, wherein the first reader topology comprises a user equipment reader.

Aspect 17: The method of aspect 15, wherein the first reader topology comprises a network entity reader.

Aspect 18: The method of any of aspects 1 through 17, further comprising: identifying the second symbol duration for the transmission of the data from a mapping of different symbol durations to different reader topologies.

Aspect 19: The method of any of aspects 1 through 18, further comprising: transmitting a clock calibration signal associated with the preamble, wherein the clock calibration signal indicates the second symbol duration.

Aspect 20: The method of any of aspects 1 through 19, further comprising: transmitting a clock calibration signal associated with the preamble, wherein the clock calibration signal comprises an indication of the second symbol duration.

Aspect 21: The method of any of aspects 1 through 20, wherein the apparatus is configured as a user equipment.

Aspect 22: The method of any of aspects 1 through 21, wherein the apparatus is configured as a network entity.

Aspect 23: A method for wireless communication at an apparatus, the method comprising: receiving a preamble according to a first symbol duration; and receiving data associated with the preamble, the data being received according to a second symbol duration different from the first symbol duration.

Aspect 24: The method of aspect 23, further comprising: receiving a clock calibration signal associated with the preamble.

Aspect 25: The method of aspect 24, further comprising: receiving the clock calibration signal according to the second symbol duration.

Aspect 26: The method of aspect 24, further comprising: receiving the clock calibration signal according to a third symbol duration different from the first symbol duration and the second symbol duration.

Aspect 27: The method of any of aspects 23 through 26, wherein: the first symbol duration corresponds to a first orthogonal frequency division multiplexing (OFDM) chip rate; and the second symbol duration corresponds to a second OFDM chip rate different from the first OFDM chip rate.

Aspect 28: The method of any of aspects 23 through 27, wherein: the first symbol duration corresponds to a first quantity of on-off keying (OOK) symbols being mapped to each orthogonal frequency division multiplexing (OFDM) symbol used for the reception of the preamble; the second symbol duration corresponds to a second quantity of OOK symbols being mapped to each OFDM symbol used for the reception of the data; and the second quantity is different from the first quantity.

Aspect 29: The method of aspect 28, wherein: the first quantity is one; and the second quantity is greater than one.

Aspect 30: The method of any of aspects 23 through 29, wherein: the preamble comprises an OOK-1 sequence; and the data comprises an OOK-4 sequence.

Aspect 31: The method of any of aspects 23 through 30, wherein: the preamble comprises an on-off keying (OOK) sequence associated with a first chip rate; and the data comprises the OOK sequence associated with a second chip rate different from the first chip rate.

Aspect 32: The method of aspect 31, wherein the OOK sequence is an OOK-4 sequence.

Aspect 33: The method of any of aspects 23 through 32, wherein the second symbol duration is associated with a first frequency band.

Aspect 34: The method of any of aspects 23 through 33, further comprising: identifying the second symbol duration for the reception of the data from a mapping of different symbol durations to different frequency bands.

Aspect 35: The method of any of aspects 23 through 34, wherein the first symbol duration is associated with a first frequency band.

Aspect 36: The method of any of aspects 23 through 35, further comprising: identifying the first symbol duration for the reception of the preamble from a mapping of different symbol durations to different frequency bands.

Aspect 37: The method of any of aspects 23 through 36, wherein the second symbol duration is associated with a first reader topology.

Aspect 38: The method of aspect 37, wherein the first reader topology comprises a user equipment reader.

Aspect 39: The method of aspect 37, wherein the first reader topology comprises a network entity reader.

Aspect 40: The method of any of aspects 1 through 39, further comprising: identifying the second symbol duration for the reception of the data from a mapping of different symbol durations to different reader topologies.

Aspect 41: The method of any of aspects 1 through 40, further comprising: receiving a clock calibration signal associated with the preamble, wherein the clock calibration signal indicates the second symbol duration.

Aspect 42: The method of any of aspects 1 through 41, further comprising: receiving a clock calibration signal associated with the preamble, wherein the clock calibration signal comprises an indication of the second symbol duration.

Aspect 43: An apparatus, comprising: one or more memories storing processor-executable code; and one or more processors configured to execute the processor-executable code and cause the apparatus to perform a method in accordance with any one or more of aspects 1 through 22.

Aspect 44: A user equipment, comprising: one or more memories storing processor-executable code; and one or more processors configured to execute the processor-executable code and cause the user equipment to perform a method in accordance with any one or more of aspects 1 through 22.

Aspect 45: A network entity, comprising: one or more memories storing processor-executable code; and one or more processors configured to execute the processor-executable code and cause the network entity to perform a method in accordance with any one or more of aspects 1 through 22.

Aspect 46: An apparatus configured for communication comprising at least one means for performing any one or more of aspects 1 through 22.

Aspect 47: A non-transitory computer-readable medium storing processor-executable code, comprising code for causing an apparatus to perform any one or more of aspects 1 through 22.

Aspect 48: An apparatus, comprising: one or more memories storing processor-executable code; and one or more processors configured to execute the processor-executable code and cause the apparatus to perform a method in accordance with any one or more of aspects 23 through 42.

Aspect 49: An apparatus configured for communication comprising at least one means for performing any one or more of aspects 23 through 42.

Aspect 50: A non-transitory computer-readable medium storing processor-executable code, comprising code for causing an apparatus to perform any one or more of aspects 23 through 42.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-20 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-3, 5, 6, 7, 10, 11, and 16 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising:
one or more memories; and
one or more processors coupled to the one or more memories and configured to:
transmit a preamble according to a first symbol duration; and
transmit data associated with the preamble, the data being transmitted according to a second symbol duration different from the first symbol duration.

2. The apparatus of claim 1, wherein the one or more processors are further configured to:
transmit a clock calibration signal associated with the preamble.

3. The apparatus of claim 2, wherein the one or more processors are further configured to:
transmit the clock calibration signal according to the second symbol duration.

4. The apparatus of claim 2, wherein the one or more processors are further configured to:
transmit the clock calibration signal according to a third symbol duration different from the first symbol duration and the second symbol duration.

5. The apparatus of claim 1, wherein:
the first symbol duration corresponds to a first orthogonal frequency division multiplexing (OFDM) chip rate; and
the second symbol duration corresponds to a second OFDM chip rate different from the first OFDM chip rate.

6. The apparatus of claim 1, wherein:
the first symbol duration corresponds to a first quantity of on-off keying (OOK) symbols being mapped to each orthogonal frequency division multiplexing (OFDM) symbol used for the transmission of the preamble;
the second symbol duration corresponds to a second quantity of OOK symbols being mapped to each OFDM symbol used for the transmission of the data; and
the second quantity is different from the first quantity.

7. The apparatus of claim 6, wherein:
the first quantity is one; and
the second quantity is greater than one.

8. The apparatus of claim 1, wherein:
the preamble comprises an OOK-1 sequence; and
the data comprises an OOK-4 sequence.

9. The apparatus of claim 1, wherein:
the preamble comprises an on-off keying (OOK) sequence associated with a first chip rate; and
the data comprises the OOK sequence associated with a second chip rate different from the first chip rate.

10. The apparatus of claim 9, wherein the OOK sequence is an OOK-4 sequence.

11. The apparatus of claim 1, wherein the second symbol duration is associated with a first frequency band.

12. The apparatus of claim 1, wherein the one or more processors are further configured to:
identify the second symbol duration for the transmission of the data from a mapping of different symbol durations to different frequency bands.

13. The apparatus of claim 1, wherein the first symbol duration is associated with a first frequency band.

14. The apparatus of claim 1, wherein the one or more processors are further configured to:
identify the first symbol duration for the transmission of the preamble from a mapping of different symbol durations to different frequency bands.

15. The apparatus of claim 1, wherein at least one of:
the second symbol duration is associated with a first reader topology;
the first reader topology comprises a user equipment reader; or
the first reader topology comprises a network entity reader.

16. The apparatus of claim 1, wherein the one or more processors are further configured to:
identify the second symbol duration for the transmission of the data from a mapping of different symbol durations to different reader topologies.

17. The apparatus of claim 1, wherein the one or more processors are further configured to:
transmit a clock calibration signal associated with the preamble, wherein the clock calibration signal indicates the second symbol duration.

18. The apparatus of claim 1, wherein the one or more processors are further configured to:
transmit a clock calibration signal associated with the preamble, wherein the clock calibration signal comprises an indication of the second symbol duration.

19. A method for wireless communication at an apparatus, comprising:
transmitting a preamble according to a first symbol duration; and
transmitting data associated with the preamble, the data being transmitted according to a second symbol duration different from the first symbol duration.

20. A non-transitory computer-readable medium having stored therein instructions executable by one or more processors of an apparatus to:
transmit a preamble according to a first symbol duration; and
transmit data associated with the preamble, the data being transmitted according to a second symbol duration different from the first symbol duration.
